(19) United States
(12) Patent Application Publication
(10) Pub. No.: US 2024/0163739 A1
(43) Pub. Date: May 16, 2024

(54) CONDITIONAL PRIMARY SECONDARY CELL CHANGE CONFIGURATION WITHIN A CONDITIONAL CELL ADDITION OR CHANGE CONFIGURATION

(71) Applicant: QUALCOMM Incorporated, San Diego, CA (US)

(72) Inventors: Punyaslok PURKAYASTHA, San Diego, CA (US); Ozcan OZTURK, San Diego, CA (US)

(21) Appl. No.: 18/055,176

(22) Filed: Nov. 14, 2022

(51) Int. Cl. H04W 36/00

(52) U.S. Cl. CPC H04W 36/0058; H04W 36/0061; H04W 36/0069

(57) ABSTRACT

Various aspects of the present disclosure generally relate to wireless communication. In some aspects, a user equipment (UE) may receive configuration information indicating: one of a conditional primary secondary cell (PSCell) addition (CPA) configuration associated with a CPA procedure or a conditional PSCell change (CPC) configuration associated with a first CPC procedure, and a subsequent CPC configuration associated with a second CPC procedure. The UE may perform one of the CPA procedure or the first CPC procedure based at least in part on the one of the CPA configuration or the CPC configuration. The UE may perform the second CPC procedure based at least in part on the subsequent CPC configuration. Numerous other aspects are described.

### FIELD OF THE DISCLOSURE

Aspects of the present disclosure generally relate to wireless communication and to techniques and apparatuses for a conditional primary secondary cell change configuration within a conditional cell addition or change configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information indicating one of a conditional primary secondary cell (PSCell) addition (CPA) configuration associated with a CPA procedure or a conditional PSCell change (CPC) configuration associated with a first CPC procedure, and a subsequent CPC configuration associated with a second CPC procedure. The method may include performing one of the CPA procedure or the first CPC procedure based at least in part on the one of the CPA configuration or the CPC configuration. The method may include performing the second CPC procedure based at least in part on the subsequent CPC configuration.

Some aspects described herein relate to a method of wireless communication performed by a network node. The method may include receiving, from one or more other network nodes, multiple secondary cell group (SCG) configurations. The method may include transmitting, to a UE, configuration information based at least in part on the multiple SCG configurations, the configuration information indicating, one of a CPA configuration associated with a CPA procedure or a CPC configuration associated with a first CPC procedure, and a subsequent CPC configuration associated with a second CPC procedure.

Some aspects described herein relate to a UE for wireless communication. The UE may include a memory and one or more processors coupled to the memory. The one or more processors may be configured to receive configuration information indicating one of a CPA configuration associated with a CPA procedure or a CPC configuration associated with a first CPC procedure, and a subsequent CPC configuration associated with a second CPC procedure. The one or more processors may be configured to perform one of the CPA procedure or the first CPC procedure based at least in part on the one of the CPA configuration or the CPC configuration. The one or more processors may be configured to perform the second CPC procedure based at least in part on the subsequent CPC configuration.

Some aspects described herein relate to a network node for wireless communication. The network node may include a memory and one or more processors coupled to the memory. The one or more processors may be configured to receive, from one or more other network nodes, multiple SCG configurations. The one or more processors may be configured to transmit, to a UE, configuration information based at least in part on the multiple SCG configurations, the configuration information indicating one of a CPA configuration associated with a CPA procedure or a CPC configuration associated with a first CPC procedure, and a subsequent CPC configuration associated with a second CPC procedure.

Some aspects described herein relate to a non-transitory computer-readable medium that stores a set of instructions for wireless communication by a UE. The set of instructions, when executed by one or more processors of the UE, may cause the UE to receive configuration information indicating one of a CPA configuration associated with a CPA procedure or a CPC configuration associated with a first CPC procedure, and a subsequent CPC configuration associated with a second CPC procedure. The set of instructions, when executed by one or more processors of the UE, may cause the UE to perform one of the CPA procedure or the first CPC procedure based at least in part on the one of the CPA configuration or the CPC configuration. The set of instructions, when executed by one or more processors of the UE, may cause the UE to perform the second CPC procedure based at least in part on the subsequent CPC configuration.

Some aspects described herein relate to a non-transitory computer-readable medium that stores a set of instructions for wireless communication by a network node. The set of instructions, when executed by one or more processors of the network node, may cause the network node to receive, from one or more other network nodes, multiple SCG configurations. The set of instructions, when executed by one or more processors of the network node, may cause the network node to transmit, to a UE, configuration information based at least in part on the multiple SCG configurations, the configuration information indicating one of a CPA configuration associated with a CPA procedure or a CPC configuration associated with a first CPC procedure, and a subsequent CPC configuration associated with a second CPC procedure.

Some aspects described herein relate to an apparatus for wireless communication. The apparatus may include means for receiving configuration information indicating one of a CPA configuration associated with a CPA procedure or a CPC configuration associated with a first CPC procedure, and a subsequent CPC configuration associated with a second CPC procedure. The apparatus may include means for performing one of the CPA procedure or the first CPC procedure based at least in part on the one of the CPA configuration or the CPC configuration. The apparatus may include means for performing the second CPC procedure based at least in part on the subsequent CPC configuration.

Some aspects described herein relate to an apparatus for wireless communication. The apparatus may include means for receiving, from one or more other network nodes, multiple SCG configurations. The apparatus may include means for transmitting, to a UE, configuration information based at least in part on the multiple SCG configurations, the configuration information indicating one of a CPA configuration associated with a CPA procedure or a CPC configuration associated with a first CPC procedure, and a subsequent CPC configuration associated with a second CPC procedure.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of dual connectivity, in accordance with the present disclosure.

FIGS. 5A-5B are diagrams of an example associated with a condition primary secondary cell (PSCell) change (CPC) configuration within a CPC configuration, in accordance with the present disclosure.

FIGS. 6A-6B are diagrams of an example associated with a CPC configuration within a CPC configuration, in accordance with the present disclosure.

FIGS. 7A-7B are diagrams of an example associated with a CPC configuration within a CPC configuration, in accordance with the present disclosure.

FIGS. 8A-8B are diagrams of an example associated with a CPC configuration within a conditional PSCell addition (CPA) configuration, in accordance with the present disclosure.

FIGS. 9A-9B are diagrams of an example associated with a CPC configuration within a CPC configuration, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

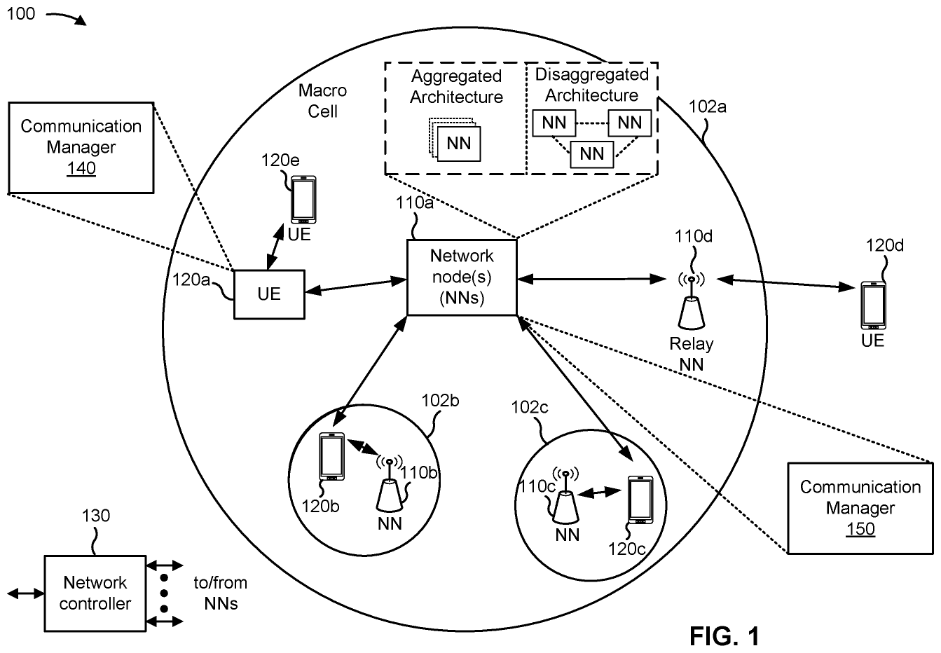

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating: one of a conditional primary secondary cell (PSCell) addition (CPA) configuration associated with a CPA procedure or a conditional PSCell change (CPC) configuration associated with a first CPC procedure, and a subsequent CPC configuration associated with a second CPC procedure; perform one of the CPA procedure or the first CPC procedure based at least in part on the one of the CPA configuration or the CPC configuration; and perform the second CPC procedure based at least in part on the subsequent CPC configuration. Additionally, or alternatively, the communication manager 140 may perform one or more other operations described herein.

In some aspects, the network node 110 may include a communication manager 150. As described in more detail elsewhere herein, the communication manager 150 may receive, from one or more other network nodes, multiple secondary cell group (SCG) configurations; and transmit, to a UE, configuration information based at least in part on the multiple SCG configurations, the configuration information indicating: one of a CPA configuration associated with a CPA procedure or a CPC configuration associated with a first CPC procedure, and a subsequent CPC configuration associated with a second CPC procedure. Additionally, or alternatively, the communication manager 150 may perform one or more other operations described herein.

As indicated above, FIG. 1 is provided as an example. Other examples may differ from what is described with regard to FIG. 1.

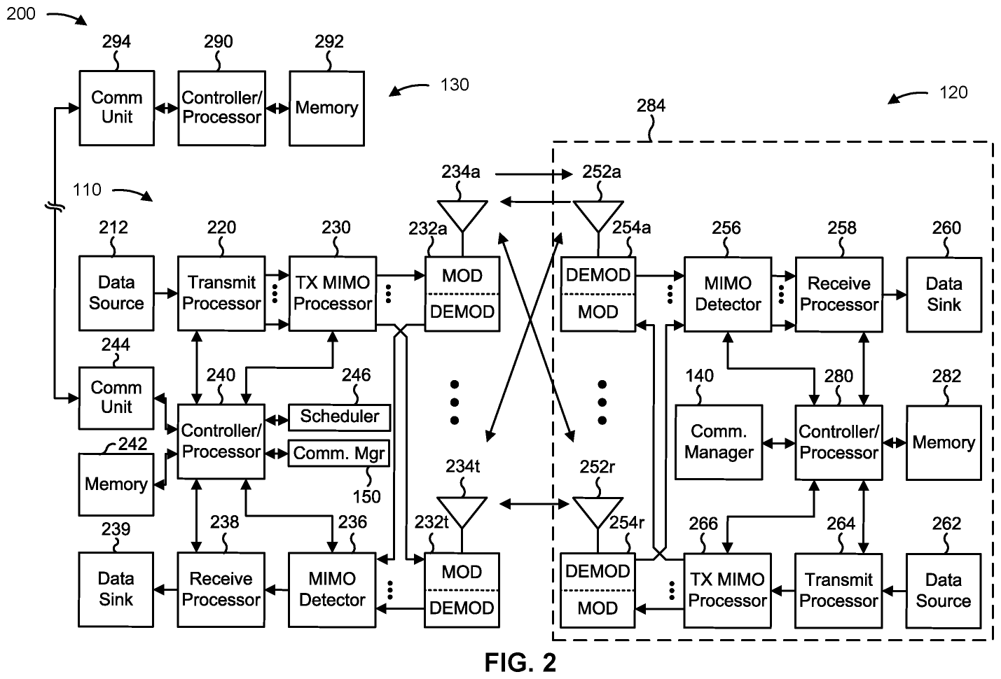

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

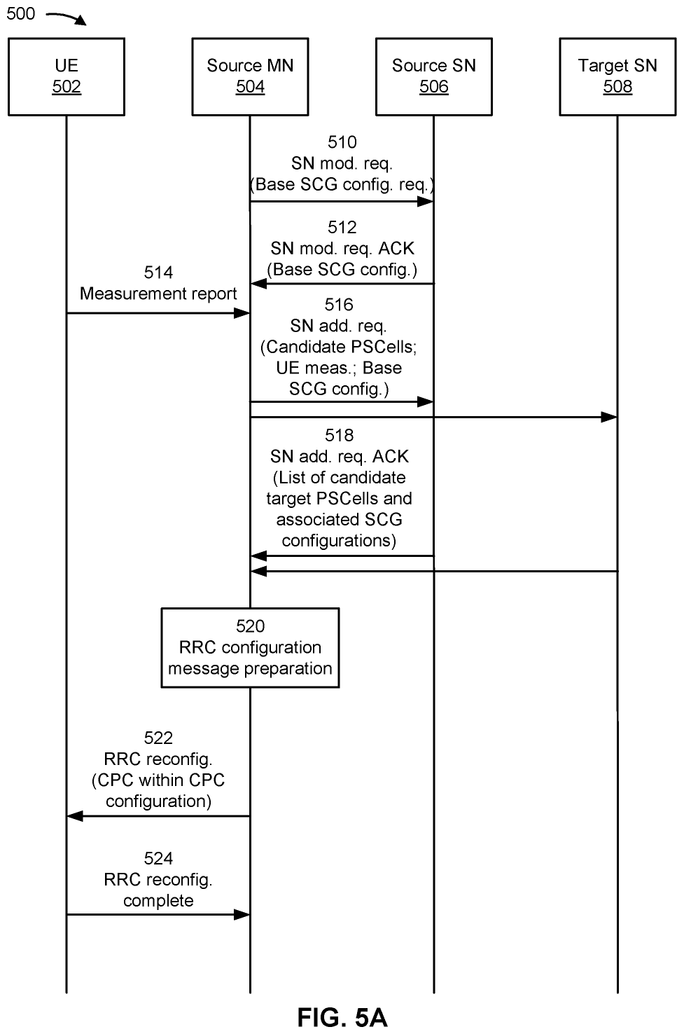

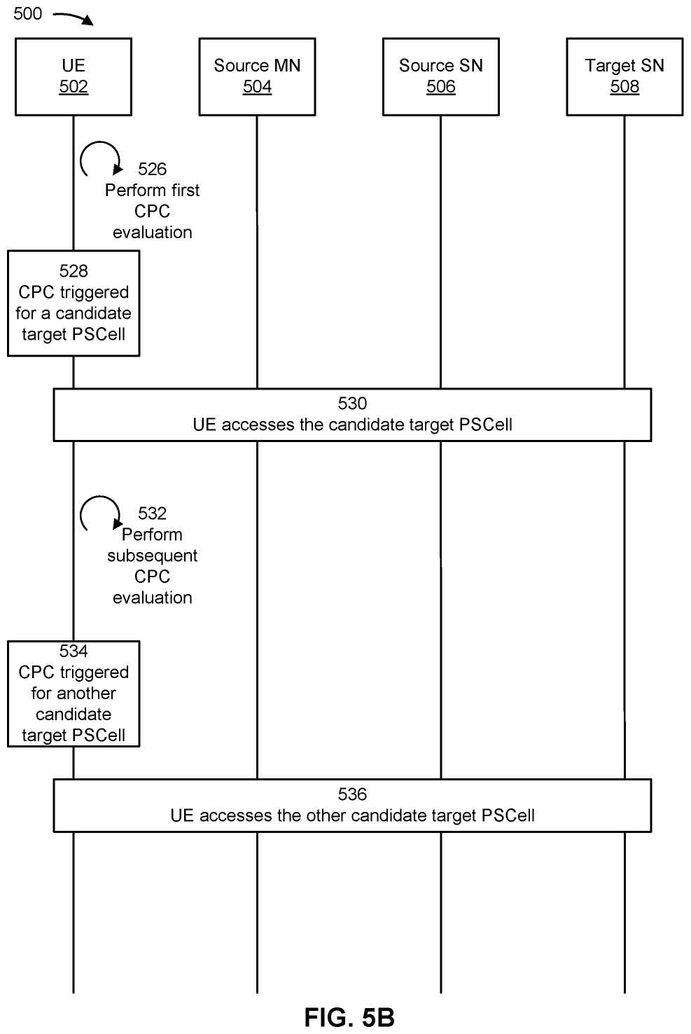

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-13).

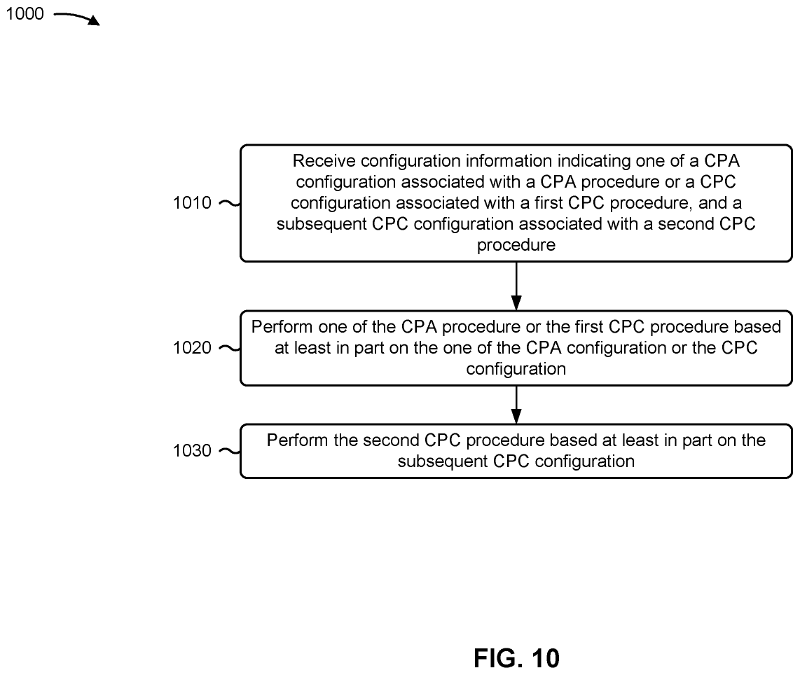

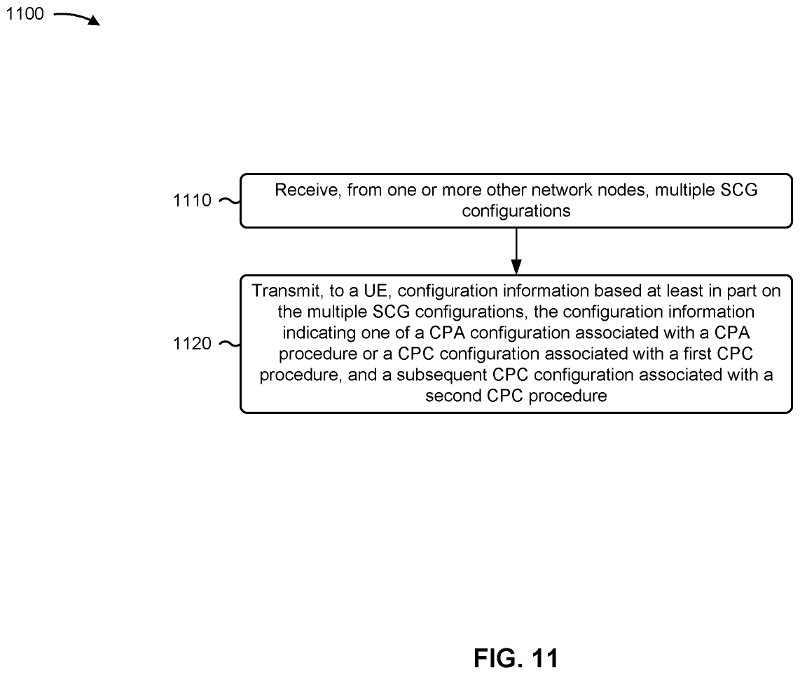

The controller/processor 240 of the network node 110, the controller/processor 280 of the UE 120, and/or any other component(s) of FIG. 2 may perform one or more techniques associated with a conditional primary secondary cell change configuration within a conditional cell addition or change configuration, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving configuration information indicating: one of a CPA configuration associated with a CPA procedure or a CPC configuration associated with a first CPC procedure, and a subsequent CPC configuration associated with a second CPC procedure (e.g., using antenna 252, modem 254, MIMO detector 256, receive processor 258, controller/processor 280, memory 282, or the like); means for performing one of the CPA procedure or the first CPC procedure based at least in part on the one of the CPA configuration or the CPC configuration (e.g., using controller/processor 280, memory 282, or the like); and/or means for performing the second CPC procedure based at least in part on the subsequent CPC configuration (e.g., using controller/processor 280, memory 282, or the like). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from one or more other network nodes, multiple SCG configurations (e.g., using antenna 234, modem 232, MIMO detector 236, receive processor 238, controller/processor 240, memory 242, or the like); and/or means for transmitting, to a UE, configuration information based at least in part on the multiple SCG configurations, the configuration information indicating: one of a CPA configuration associated with a CPA procedure or a CPC configuration associated with a first CPC procedure, and a subsequent CPC configuration associated with a second CPC procedure (e.g., using controller/processor 240, transmit processor 220, TX MIMO processor 230, modem 232, antenna 234, memory 242, or the like). The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

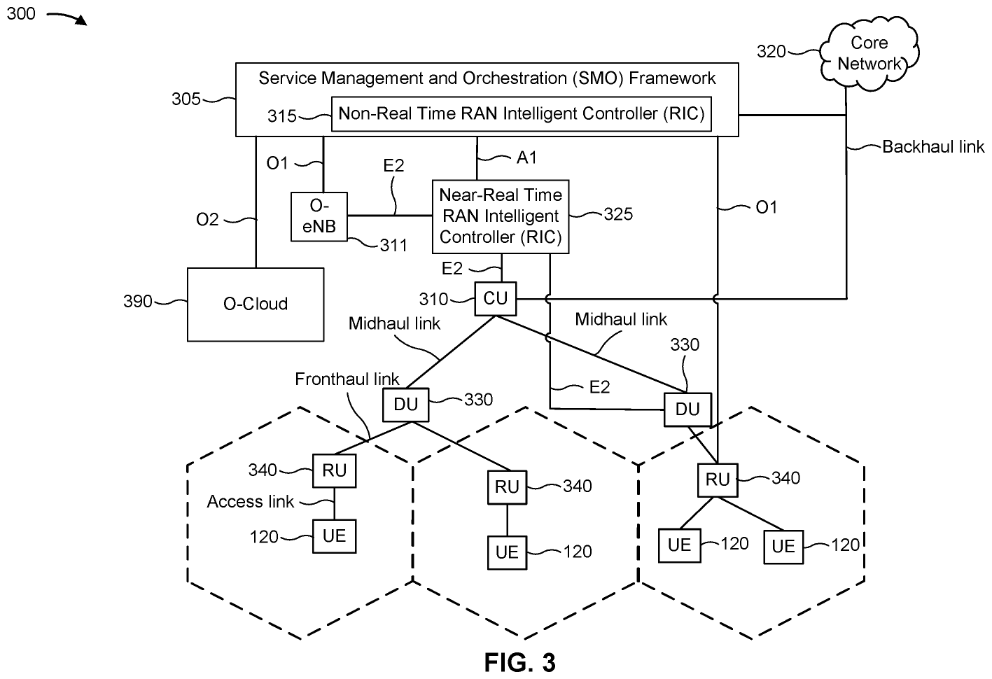

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT MC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

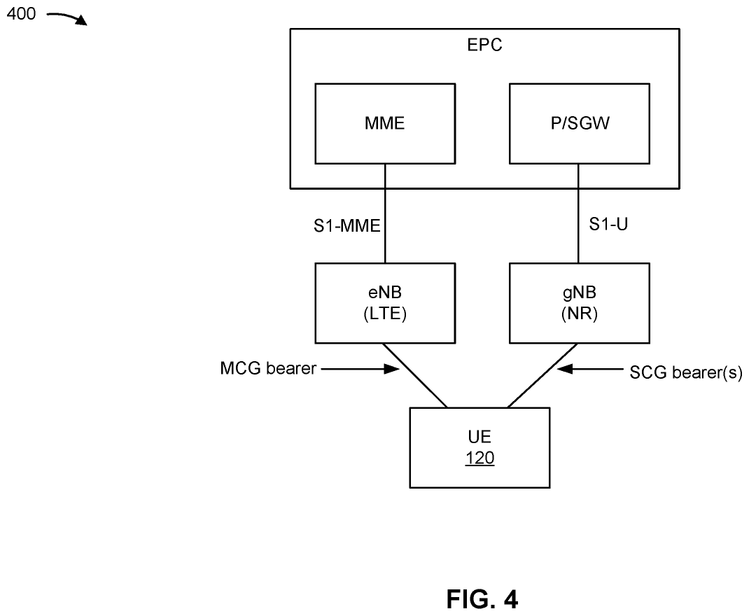

FIG. 4 is a diagram illustrating an example 400 of dual connectivity, in accordance with the present disclosure. The example shown in FIG. 4 is for an Evolved Universal Mobile Telecommunications System Terrestrial Radio Access (E-UTRA)-NR dual connectivity (ENDC) mode. In the ENDC mode, a UE 120 communicates using an LTE RAT on a master cell group (MCG), and the UE 120 communicates using an NR RAT on an SCG. However, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

As shown in FIG. 4, a UE 120 may communicate with both an eNB (e.g., a 4G network node 110) and a gNB (e.g., a 5G network node 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 4, the PGW and the SGW are shown collectively as P/SGW. In some aspects, the eNB and the gNB may be co-located at the same network node 110. In some aspects, the eNB and the gNB may be included in different network nodes 110 (e.g., may not be co-located).

As further shown in FIG. 4, in some aspects, a wireless network that permits operation in a 5G NSA mode may permit such operations using an MCG for a first RAT (e.g., an LTE RAT or a 4G RAT in the example shown in FIG. 4, but which may an NR RAT or a 5G RAT in other examples, such as NRDC examples) and an SCG for a second RAT (e.g., an NR RAT or a 5G RAT). In this case, the UE 120 may communicate with the eNB via the MCG, and may communicate with the gNB via the SCG. In some aspects, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some aspects, a UE 120 operating in a dual connectivity mode may be concurrently connected with an LTE network node 110 (e.g., an eNB) and an NR network node 110 (e.g., a gNB) (e.g., in the case of ENDC or NEDC), or may be concurrently connected with one or more network nodes 110 that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., RRC information and/or measurement reports) using one or more SRBs. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

A UE 120 may use dual connectivity to connect to multiple cells at once. For example, the UE 120 may select a set of candidate cells, and may select one or more primary cells (PCells), secondary cells (SCells), PSCells, and/or special cells (SpCells). A PCell and an SCell may be referred to as serving cells. A serving cell is a cell on which a UE 120 may transmit or receive data communications. In some example, “SpCell” may refer to a PCell of an MCG or a PSCell of an SCG. An SpCell may be a cell on which a UE 120 may transmit or receive control signaling, random access channel (RACH) messages, or similar communications, in addition to data communications. In some dual connectivity modes, a network node 110 associated with an MCG and/or a PCell may be referred to as a master node (MN), and/or a network node 110 associated with an SCG and/or a PSCell may be referred to as a secondary node (SN). Accordingly, in some examples, an MN may refer to a network node 110 from which the UE 120 may receive data and control communications, and an SN may refer to a network node 110 from which the UE 120 may receive data communications.

In some aspects, a UE 120 may be provided with conditional configurations for performing an PSCell cell change or addition if one more execution conditions are met. For example, a UE 120 may be provided with a CPC configuration associated with a CPC procedure and/or a CPA configuration associated with a CPA procedure. In examples in which the UE 120 is provided with a CPC configuration, the UE 120 may change a PSCell (e.g., perform a CPC procedure) if one or more execution conditions are met, such as if a measurement (e.g., an RSRP measurement, an RSSI measurement, an RSRQ measurement, a signal to interference plus noise ratio (SINR) measurement, or similar measurement) associated with a current PSCell falls below a certain threshold, if a measurement associated with a candidate cell (sometimes referred to as a target cell) exceeds a certain threshold, if a measurement associated with a candidate cell becomes better (e.g., offset) from a corresponding measurement associated with the current PSCell by a certain threshold amount, or a similar execution condition. Similarly, in examples in which the UE 120 is provided with a CPA configuration, the UE 120 may add a PSCell (e.g., may perform a CPA procedure and/or enter a dual connectivity mode) if one or more execution conditions are met, such as if a measurement (e.g., an RSRP measurement, an RSSI measurement, an RSRQ measurement, an SINR measurement, or similar measurement) associated with a candidate cell exceeds a certain threshold, or a similar execution condition.

In such examples, after performing the CPC procedure or the CPA procedure, the UE 120 may discard the corresponding CPC configuration or CPA configuration. In some examples, the UE 120 may then receive another CPC configuration (sometimes referred to a subsequent CPC configuration) for performing a subsequent CPC procedure (sometimes referred to as another CPC procedure or a second CPC procedure). The UE 120 may use the subsequent CPC configuration when performing a subsequent CPC procedure, such as when one or more execution conditions associated with another target cell are satisfied. In this regard, the subsequent CPC procedure may be associated with high latency and/or high overhead because the UE 120 may need to be reconfigured between an initial CPC or CPA procedure and the subsequent CPC procedure.

Some techniques and apparatuses described herein enable a subsequent CPC configuration to be included within an initial CPA configuration or an initial CPC configuration. In this way, a UE 120 may be configured to add a PSCell (e.g., perform an initial CPA procedure) or change a PSCell (e.g., perform an initial CPC procedure) if initial execution conditions met, as well as change a PSCell after the initial PSCell addition or change (e.g., perform a subsequent CPC procedure) without requiring the UE 120 to be reconfigured with a subsequent CPC configuration. As a result, the subsequent CPC procedure may be associated with reduced latency and/or reduced overhead as compared to traditional CPC procedures, because the UE 120 does not need to be reconfigured between an initial CPC or CPA procedure and the subsequent CPC procedure.

As indicated above, FIG. 4 is provided as an example. Other examples may differ from what is described with respect to FIG. 4.

FIGS. 5A-5B are diagrams of an example 500 associated with a CPC configuration within a CPC configuration, in accordance with the present disclosure. More particularly, FIGS. 5A-5B are diagrams of an MN-initiated procedure for a CPC configuration within a CPC configuration, which may be a procedure in which an MN (rather than an SN) receives a measurement report from a UE, thereby triggering a PSCell change procedure.

As shown in FIGS. 5A-5B, a UE 502 (e.g., UE 120), a source MN 504 (e.g., network node 110, a CU, a DU, and/or an RU), a source SN 506 (e.g., network node 110, a CU, a DU, and/or an RU), and/or a target SN 508 (e.g., network node 110, a CU, a DU, and/or an RU) may communicate with one another. In some aspects, the UE 502, the source MN 504, the source SN 506, and/or the target SN 508 may be part of a wireless network (e.g., wireless network 100). The UE 502, the source MN 504, the source SN 506, and/or the target SN 508 may have established a wireless connection prior to operations shown in FIGS. 5A-5B, and/or the UE 502, the source MN 504, the source SN 506, and/or the target SN 508 may be capable of operating in a dual connectivity mode, such as one of the example dual connectivity modes described above in connection with FIG. 4. For example, in the example 500 shown in FIGS. 5A-5B, the UE 502 may have established a dual connection with the source MN 504 and the source SN 506 prior to operations shown in FIGS. 5A-5B.

As shown in FIG. 5A, and as indicated by reference number 510, the source MN 504 may transmit, and the source SN may receive, an SN modification request (shown as “SN mod. req.”) or similar communication. In some aspects, the SN modification request communication may include a request for information associated with an SCG. For example, in some aspects, the SN modification request communication may include a base SCG configuration request (shown as “Base SCG config. req.”), requesting a base SCG configuration to be used for one or more CPC procedures. In some aspects, a base SCG configuration may refer to a set of base configuration parameters that are common to all SCG configurations associated with accessing cells within an SCG. The particular contents of the base SCG configuration may be based at least in part on network implementation. In some aspects, the base SCG configuration as well as a delta SCG configuration for each target cell (e.g., an indication of a change in configuration parameters from the base SCG configuration for the corresponding target cell) may be provided to the UE 502, such that the UE 502 may access one or more cells via a CPC procedure or similar procedure. Aspects of a base SCG configuration and one or more delta configurations are described in more detail below in connection with reference number 520.

In some aspects, in response to receiving the communication described above in connection with reference number 510 (more particularly, in response to receiving the base SCG configuration request), the source SN 506 may determine a base SCG configuration to be used for one or more CPC procedures, such as for an initial (e.g., first) CPC procedure and/or for a subsequent (e.g., second) CPC procedure. In that regard, and as shown by reference number 512, the source SN 506 may transmit, and the source MN 504 may receive, a SN modification request acknowledgement (ACK) communication (shown as “SN mod. req. ACK”) or similar communication, which may include an indication of the base SCG configuration (shown as “Base SCG config.”).

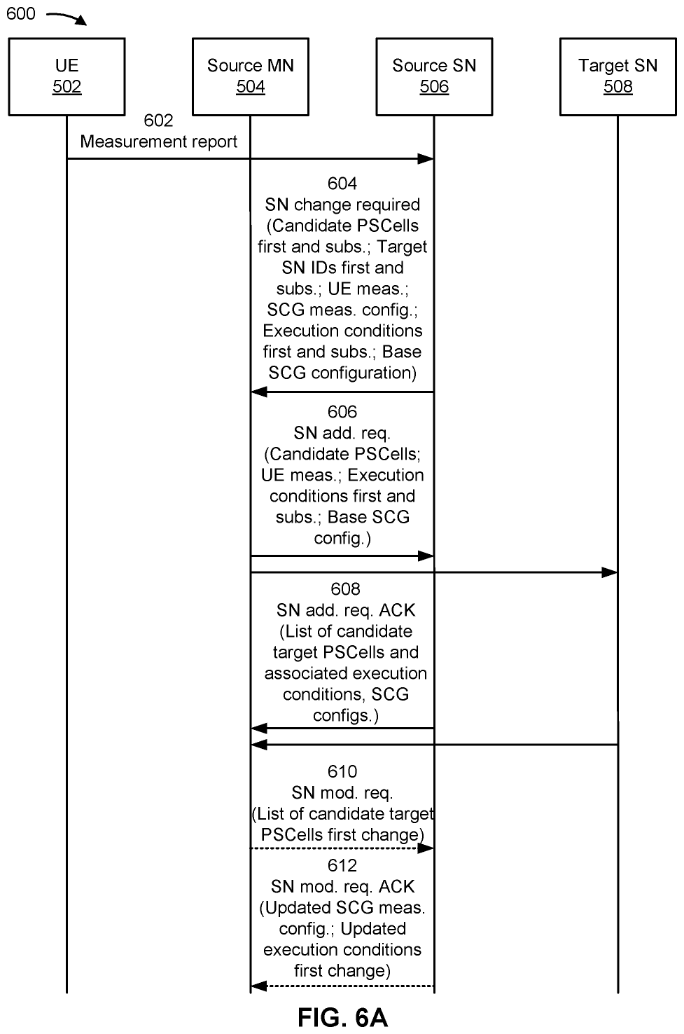

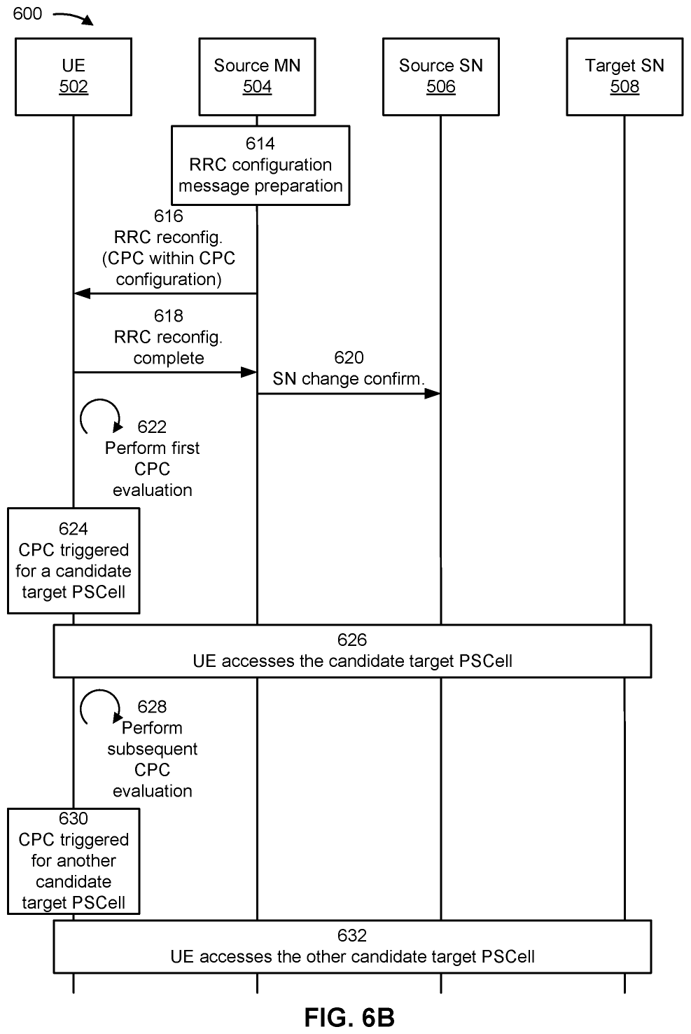

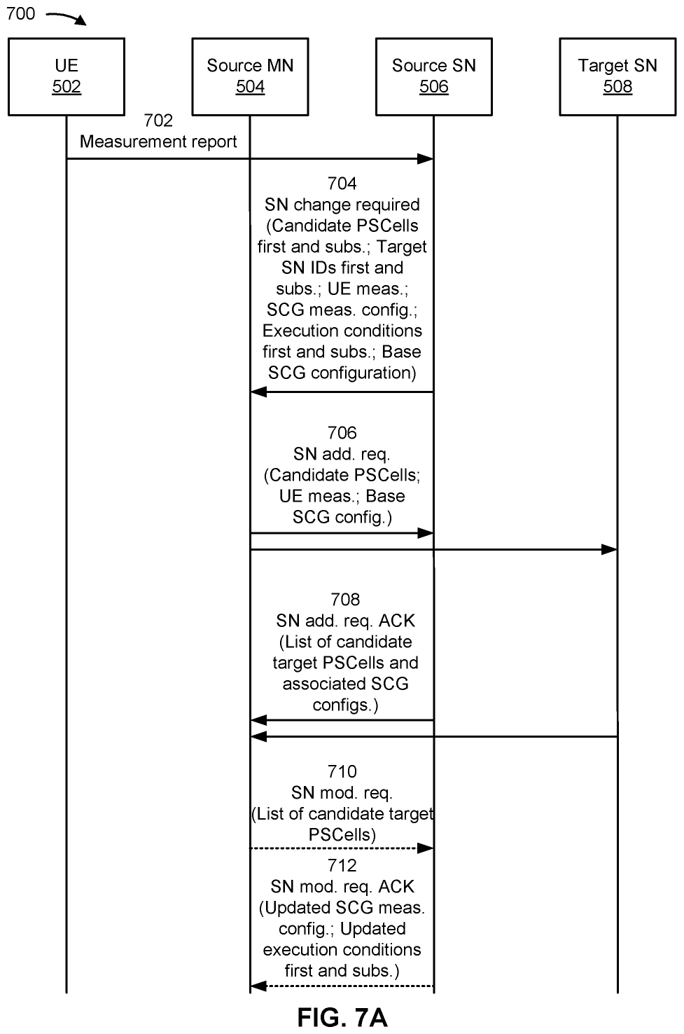

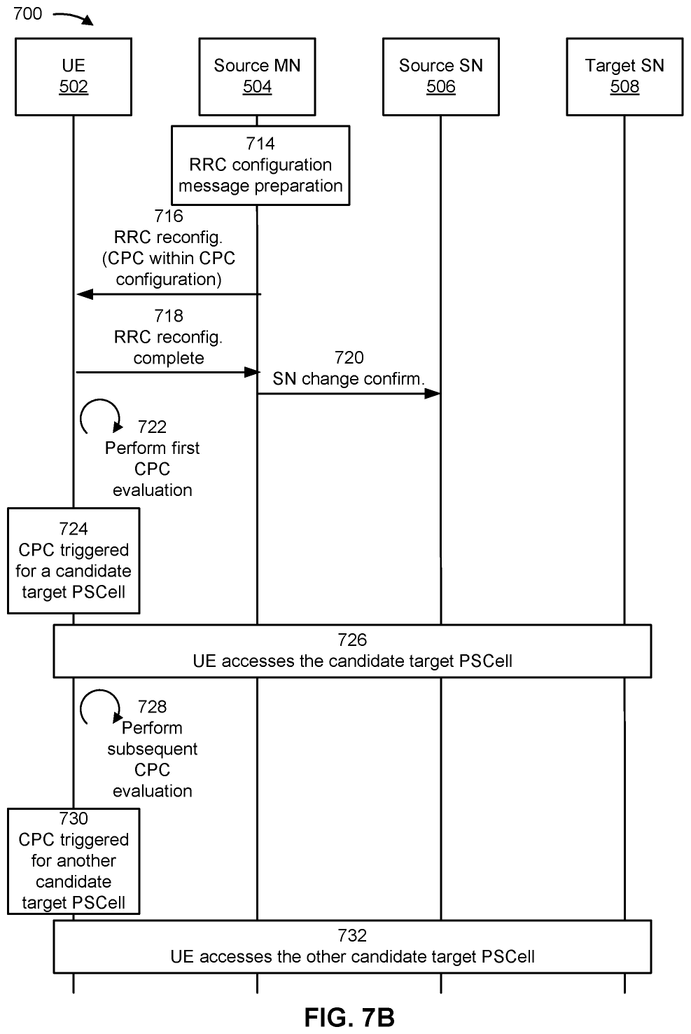

As shown by reference number 514, in MN-initiated procedures, the UE 502 may transmit, and the source MN 504 may receive, a measurement report. In some other procedures, such as in SN-initiated procedures, which are described in more detail below in connection with FIGS. 6A-7B, the UE 502 may transmit a measurement report to a different entity (e.g., the source SN 506). The measurement report may indicate measurements associated with one or more cells. For example, the UE 502 may be configured to perform periodic measurements on nearby cells, such as RSRP measurements, RSSI measurements, RSRQ measurements, SINR measurements, or similar measurements. In such aspects, the UE 502 may prepare and transmit the measurement report, indicating the various measurements of the nearby cells. These measurements may in turn be utilized by the network to determine certain candidate cells for a CPC procedure or similar procedure.

More particularly, as shown by reference number 516, based at least in part on the measurement report, the source MN 504 may transmit, and one or more network nodes associated with candidate PSCells (e.g., nearby cells that, based at least in part on information indicated in the measurement report, are candidates to serve as a PSCell in the future) may receive, the base SCG configuration, among other information. More particularly, in the example shown in FIG. 5A, the source MN 504 may transmit, and the source SN 506 and/or the target SN 508 may receive, an SN addition request (shown as “SN add. req.”) communication or a similar communication. The communication may indicate candidate PSCells, UE measurements (shown as “UE meas.,” which may be measurements associated with each candidate PSCell and/or measurements included in the measurement report described above in connection with reference number 514), or the base SCG configuration, among other information.

In response, and as shown by reference number 518, the source SN 506 and/or the target SN 508 may transmit, and the source MN 504 may receive, an SN addition request ACK communication (shown as “SN add. req. ACK”) or similar communication, indicating configuration parameters associated with certain candidate PSCells associated with the source SN 506 and/or the target SN 508. For example, the SN addition request ACK communication from each node may include a list of candidate target PSCells and a corresponding SCG configuration associated with each candidate target PSCell. In some aspects, the corresponding SCG configuration associated with each candidate target PSCell may be indicated as a delta configuration with respect to the base SCG configuration. In some aspects, an SN (e.g., the source SN 506 and/or the target SN 508) transmitting an SN addition request ACK communication or similar communication may include an indication in the communication for each target PSCell indicating whether the corresponding SCG configuration is a delta configuration with respect to the base SCG configuration.

As shown by reference number 520, based at least in part on the information received via the one or more communications described above in connection with reference numbers 510-518, the source MN 504 may prepare an RRC configuration message or a similar configuration message. In some aspects, preparing the RRC configuration message or similar configuration message may include preparing a message including a CPC configuration within a CPC configuration (e.g., a configuration associated with a subsequent CPC procedure within a configuration associated with a first CPC procedure). In some aspects, a CPC configuration within a CPC configuration may be referred to simply as a “CPC within CPC configuration.” In some aspects, the RRC configuration message or similar configuration message may include: (1) a base SCG configuration; (2) a base MCG configuration (e.g., a set of base configuration parameters associated with accessing cells within an MCG, the particular contents of which may be based at least in part on network implementation); (3) a CPC configuration (sometimes referred to as a first CPC configuration) including a set of candidate target PSCells, execution conditions for accessing the candidate target PSCells, and/or an SCG configuration and an MCG configuration associated with each candidate target PSCell (including, in some aspects, measurement identifiers associated with the execution conditions, which may correspond to a source MCG measurement configuration); and (4) for each candidate target PSCell indicated by the CPC configuration, a subsequent CPC configuration including a set of candidate target PSCells, execution conditions for accessing the candidate target PSCells, and/or an SCG configuration and an MCG configuration associated with each candidate target PSCell (including, in some aspects, measurement identifiers associated with the execution conditions, which may correspond to a target MCG measurement configuration). In some aspects, at the operations shown in connection with reference number 520, the source MN 504 may determine the base MCG configuration to be used for the first CPC procedure. Additionally, or alternatively, MCG configurations associated with candidate target PSCells may be indicated as a delta configuration with respect to the base MCG configuration.

As shown by reference number 522, the source MN 504 may transmit, and the UE 502 may receive, configuration information. In some aspects, the UE 502 may receive the configuration information via one or more of RRC signaling, one or more MAC control elements (MAC-CEs), and/or downlink control information (DCI), among other examples. For example, in some aspects, the source MN 504 may transmit, and the UE 502 may receive, the configuration information via an RRC reconfiguration message (shown as “RRC reconfig.”). In some aspects, the configuration information may include an indication of one or more configuration parameters (e.g., already known to the UE 502 and/or previously indicated by the source MN 504 or other network device) for selection by the UE 502, and/or explicit configuration information for the UE 502 to use to configure the UE 502, among other examples.

In some aspects, the configuration information may indicate the CPC within CPC configuration, as described above in connection with reference number 520. Put another way, in some aspects, the source MN 504 may transmit, and the UE 502 may receive, an RRC reconfiguration message that may indicate the base SCG configuration, the base MCG configuration, the first CPC configuration (e.g., candidate target PSCells for the first CPC procedure and associated SCG and MCG configurations), the subsequent CPC configuration (e.g., for each candidate target PSCell associated with the first CPC procedure, corresponding candidate target PSCells for subsequent CPC procedures and associated SCG and MCG configurations), and/or, for each candidate target PSCell, an indication whether the associated SCG and/or MCG configurations are delta configurations.

The UE 502 may configure itself based at least in part on the configuration information. In some aspects, the UE 502 may be configured to perform one or more operations described herein based at least in part on the configuration information. Additionally, in some aspects, the UE 502 may transmit, and the source MN 504 may receive, a message indicating that the UE 502 has configured itself based at least in part on the configuration information, such as the RRC reconfiguration complete message shown in connection with reference number 524.

As shown in FIG. 5B, and as indicated by reference numbers 526-530, based at least in part on the configuration information, the UE 502 may perform a first CPC procedure. More particularly, as indicated by reference number 526, the UE 502 may perform a first CPC evaluation based at least in part on the first CPC configuration. This may include performing measurements (e.g., RSRP measurements, RSRQ measurements, RSSI measurements, SINR measurements, or similar measurements) for frequencies associated with each candidate target PSCell indicated by the first CPC configuration, and/or determining if one or more execution conditions has been satisfied for a candidate target PSCell. As shown by reference number 528, when one or more execution conditions has been satisfied for a candidate target PSCell, the UE 502 may determine that a CPC procedure associated with the candidate target PSCell has been triggered, and may thus initiate a first CPC procedure. More particularly, as shown by reference number 530, the UE 502 may access the candidate target PSCell, such as by performing a RACH procedure associated with the candidate target PSCell.

In some aspects, upon accessing the candidate target PSCell via the operations shown in connection with reference number 530, the UE 502 may discard the source SCG and MCG configurations, the UE 502 may apply the target SCG and MCG configurations, and/or the UE 502 may discard the SCG and MCG configurations associated with other candidate target PSCells associated with the first CPC configuration. In some other aspects, the UE 502 may maintain the base SCG configuration and/or the base MCG configuration based at least in part on a network indication that the base SCG configuration and/or the base MCG configuration should be kept after the first CPC trigger. In such aspects, measurement identifiers associated with execution conditions for the subsequent CPC configuration may correspond to the source MCG configuration.

Upon accessing the candidate target PSCell for which the first CPC procedure is triggered, the UE 502 may initiate evaluation of the CPC corresponding to the newly accessed PSCell. Put another way, the CPC within CPC configuration may include a subsequent CPC configuration for each candidate target PSCell associated with the initial CPC configuration, such that, after one of the PSCells is accessed via the initial CPC procedure, the UE 502 may begin to monitor execution conditions for a subsequent CPC procedure without being reconfigured by the source MN 504. In that regard, upon accessing a PSCell via the first CPC procedure, the UE 502 may perform a subsequent CPC procedure based at least in part on a subsequent CPC configuration associated with the newly accessed PSCell.

More particularly, as indicated by reference numbers 532-536, based at least in part on the configuration information (and, more particularly, the subsequent CPC configuration), the UE 502 may perform a subsequent CPC procedure without requiring additional information from the source MN 504 (e.g., without being reconfigured by the source MN 504). More particularly, as indicated by reference number 532, the UE 502 may perform a subsequent CPC evaluation based at least in part on the subsequent CPC configuration. This may include performing measurements (e.g., RSRP measurements, RSRQ measurements, RSSI measurements, SINR measurements, or similar measurements) for frequencies associated with each candidate target PSCell indicated by the subsequent CPC configuration, and/or determining if one or more execution conditions has been satisfied for a candidate target PSCell associated with the subsequent CPC configuration. As shown by reference number 534, when one or more execution conditions has been satisfied for another candidate target PSCell associated with the subsequent CPC configuration, the UE 502 may determine that a CPC procedure associated with the other candidate target PSCell has been triggered, and thus may initiate a subsequent CPC procedure to once again change the PSCell. As shown by reference number 536, the UE 502 may thus access the other candidate target PSCell, such as by performing a RACH procedure associated with the other candidate target PSCell. In some aspects, upon accessing the other candidate target PSCell after the subsequent CPC triggers, the UE 502 may discard all stored conditional configurations as well as the source SCG and MCG configurations.

In this way, the UE 502 may perform successive CPC procedures (sometimes referred to as performing SCG selective activation procedures) via a single RRC configuration message or similar configuration message (e.g., via a single message including a CPC within CPC configuration), thereby reducing overhead and latency associated with successive PSCell changes, and/or improving link quality and thus reducing power, computing, and communication resource consumption otherwise associated with correcting communication errors. Although the aspects described in connection with FIGS. 5A-5B are associated with an MN-initiated procedure associated with a CPC within CPC configuration, in some other aspects, a CPC within CPC configuration may be associated with an SN-initiated procedure. Aspects of SN-initiated procedures associated with a CPC within CPC configuration are described in more detail below in connection with FIGS. 6A-7B.

As indicated above, FIGS. 5A-5B are provided as an example. Other examples may differ from what is described with respect to FIGS. 5A-5B.

FIGS. 6A-6B are diagrams of an example 600 associated with a CPC configuration within a CPC configuration, in accordance with the present disclosure. More particularly, FIGS. 6A-6B are diagrams of an SN-initiated procedure associated with a CPC within CPC configuration, which may be a procedure in which an SN receives a measurement report from a UE, thereby triggering a PSCell change procedure. In the aspects described in connection with FIGS. 6A-6B, the UE 502 may be configured to discard a source SCG configuration and/or a source MCG configuration after performing a first CPC procedure. Accordingly, measurement identifiers associated with execution conditions associated with a first CPC configuration may correspond to a source SCG configuration, and/or measurement identifiers associated with execution conditions associated with the subsequent CPC procedure may correspond to a target SCG configuration. In such aspects, the source SN 506 may forward certain information (e.g., measurement objects, events of the execution conditions, an indication of a serving PSCell, or similar information) to the target SN 508 during a preparation procedure in order for the target SN 508 to provide appropriate configuration information to the source MN 504 for the subsequent CPC procedure.

As shown in FIG. 6A, and as indicated by reference number 602, the UE 502 may transmit, and the source SN 506 may receive, a measurement report. In a similar manner as described above in connection with reference number 514, the measurement report may indicate measurements associated with one or more cells. For example, the UE 502 may be configured to perform periodic measurements on nearby cells, such as RSRP measurements, RSSI measurements, RSRQ measurements, SINR measurements, or similar measurements. In such aspects, the UE 502 may prepare and transmit the measurement report to the source SN 506, indicating the various measurements of the nearby cells. These measurements may in turn be utilized by the network to determine certain candidate cells for a CPC procedure or similar procedure.

As shown by reference number 604, based at least in part on receiving the measurement report, the source SN 506 may transmit, and the source MN 504 may receive, an SN change required communication or similar communication. The SN change required communication or similar communication may include certain information associated with candidate target PSCells to be forwarded by the source MN 504 to the target SN 508. Put another way, the source SN 506 may need to perform all signaling to other SNs (e.g., the target SN 508) via the source MN 504, and thus the source SN 506 may transmit the SN change required communication or similar communication to the source MN 504, which may include information to be relayed to the target SN 508.

In some aspects, the SN change required communication or similar communication may include an indication of candidate target PSCells associated with a first PSCell change (e.g., a first CPC procedure) and an indication of candidate target PSCells associated with a subsequent PSCell change (e.g., a subsequent CPC procedure). For example, in some aspects, the SN change required communication or similar communication may include an indication of target SN identifiers associated with the first and/or subsequent PSCell change, and/or candidate target PSCell identifiers associated with the first and/or subsequent PSCell change.

Additionally, or alternatively, the SN change required communication or similar communication may indicate UE 502 measurements, as indicated by the measurement report described above in connection with reference number 602. Additionally, or alternatively, the SN change required communication or similar communication may indicate execution conditions associated with the first PSCell change, and/or information associated with execution conditions for the subsequent PSCell change. For example, the information associated with execution conditions for the subsequent PSCell change may include measurement objects (e.g., frequencies) associated with the subsequent PSCell change, events associated with the execution conditions associated with the subsequent PSCell change (e.g., conditional events and time to trigger parameters, hysteresis parameters, and/or similar parameters associated with each conditional event), and/or an indication of the serving PSCell. Additionally, or alternatively, the SN change required communication or similar communication may indicate a base SCG configuration associated with the first CPC procedure, an indication of an SCG selective activation procedure (e.g., an indication that the PSCell change procedure is associated with a CPC within CPC configuration), or similar information.

As shown by reference number 606, the source MN 504 may transmit, and the source SN 506 and/or the target SN 508 may receive, an SN addition request communication or similar communication. In some aspects, the SN addition request communication or similar communication may indicate information related to execution conditions for the subsequent PSCell change that the source MN 504 received from the source SN 506, such as via the SN change required communication or similar communication. For example, in a similar manner as described above in connection with reference number 516, the communication may indicate candidate PSCells, UE measurements, and/or the base SCG configuration, in addition to execution conditions associated with the first CPC procedure and/or execution conditions associated with the subsequent CPC procedure.

In response, and as shown by reference number 608, the source SN 506 and/or the target SN 508 may transmit, and the source MN 504 may receive, an SN addition request ACK communication or similar communication, indicating configuration parameters associated with certain candidate PSCells associated with the source SN 506 and/or the target SN 508. For example, the SN addition request ACK communication from each node may include a list of candidate target PSCells, associated execution conditions associated with the subsequent PSCell change, and/or a corresponding SCG configuration associated with each candidate target PSCell. In some aspects, the corresponding SCG configuration associated with each candidate target PSCell may be indicated as a delta configuration with respect to the base SCG configuration. In some aspects, an SN (e.g., the source SN 506 and/or the target SN 508) transmitting an SN addition request ACK communication or similar communication may include an indication in the communication for each target PSCell indicating whether the corresponding SCG configuration is a delta configuration with respect to the base SCG configuration.

In some aspects, the source SN 506 may provide updated execution conditions to the source MN associated with the first PSCell change after receiving information regarding candidate target PSCells. Accordingly, in some aspects, the source MN 504 may forward information received from the target SN 508 to the source SN 506 and, in response, the source SN 506 may transmit updated execution conditions to the source MN 504. More particularly, as shown by reference number 610, the source MN 504 may transmit, and the source SN 506 may receive, an SN modification request communication (shown as “SN mod. req.”) or similar communication, indicating a list of candidate target PSCells associated with the first CPC procedure. In response, and as shown by reference number 612, the source SN 506 may transmit, and the source MN 504 may receive, an SN modification request ACK communication (shown as “SN mod. req. ACK”) or similar communication, including information associated with updated execution conditions, such as an updated SCG measurement configuration, update execution conditions associated with the first PSCell change, or similar information.

As shown in FIG. 6B, and as indicated by reference number 614, based at least in part on the information received via the one or more communications described above in connection with reference numbers 604, 608, and/or 612, the source MN 504 may prepare an RRC configuration message or a similar configuration message. The RRC configuration message preparation procedure may be performed in a substantially similar manner as described above in connection with reference number 520. Moreover, as shown by reference number 616, the source MN 504 may transmit, and the UE 502 may receive, an RRC reconfiguration message or similar message including a CPC within CPC configuration, which may be performed in a substantially similar manner as described above in connection with reference number 522. Moreover, as shown by reference number 618, the UE 502 may transmit, and the source MN 504 may receive, an RRC reconfiguration complete communication or similar communication, which may be performed in a substantially similar manner as described above in connection with reference number 524. Additionally, or alternatively, as shown by reference number 620, based at least in part on receiving the RRC reconfiguration complete message or similar communication, the source MN 504 may transmit, and the source SN 506 may receive, an SN change confirmation communication (shown as “SN change confirm.”) or similar communication, indicating that the SN change initiated the source SN 506 via the SN change required communication described above in connection with reference number 604 is complete.

Based at least in part on the CPC within CPC configuration, the UE 502 may perform a first CPC procedure and a subsequent CPC procedure in a similar manner as described above in connection with the MN-initiated procedure of FIGS. 6A-6B. More particularly, as shown by reference numbers 622, 624, and 626, the UE 502 may perform a first CPC procedure by performing a first CPC evaluation, determining that a first PSCell change has been triggered for a candidate target PSCell, and accessing the candidate target PSCell, in a substantially similar manner as described above in connection with reference numbers 526, 528, and 530. Moreover, as shown by reference numbers 628, 630, and 632, the UE 502 may perform a subsequent CPC procedure by performing a subsequent CPC evaluation, determining that a subsequent PSCell change has been triggered for another candidate target PSCell, and accessing the other candidate target PSCell, in a substantially similar manner as described above in connection with reference numbers 532, 534, and 536.

Although the operations described in connection with FIGS. 6A-6B involve an SN-initiated procedure in which the UE 502 may be configured to discard a source SCG configuration and/or a source MCG configuration after performing a first CPC procedure, in some other aspects the UE 502 may be configured to maintain a source SCG configuration and/or a source MCG configuration after performing the first CPC procedure. In such aspects, the subsequent CPC procedure may be based at least in part on the source SCG configuration and/or the source MCG configuration maintained by the UE 502. Aspects in which the UE 502 may be configured to maintain a source SCG configuration and/or a source MCG configuration after performing the first CPC procedure are described in more detail below in connection with FIGS. 7A-7B.

As indicated above, FIGS. 6A-6B are provided as an example. Other examples may differ from what is described with respect to FIGS. 6A-6B.

FIGS. 7A-7B are diagrams of an example 700 associated with a CPC configuration within a CPC configuration, in accordance with the present disclosure. More particularly, FIGS. 7A-7B are diagrams of an SN-initiated procedure associated with CPC within CPC configuration, which may be a procedure in which an SN receives a measurement report from a UE, thereby triggering a cell change procedure. In the aspects described in connection with FIGS. 7A-7B, the UE 502 may be configured to maintain (e.g., not discard) a source SCG configuration and/or a source MCG configuration after performing a first CPC procedure. Accordingly, for the subsequent CPC procedure, measurement identifiers associated with execution conditions may correspond to a source SCG configuration.

As shown in FIG. 7A, and as indicated by reference number 702, the UE 502 may transmit, and the source SN 506 may receive, a measurement report, which may be substantially similar to the measurement report described above in connection with reference number 602. As shown by reference number 704, based at least in part on receiving the measurement report, the source SN 506 may transmit, and the source MN 504 may receive, an SN change required communication or similar communication, which may be similar to the communication described above in connection with reference number 604. More particularly, the SN change required communication or similar communication may include certain information associated with candidate target PSCells to be forwarded by the source MN 504 to the target SN 508. In some aspects, the SN change required communication or similar communication may include an indication of target SN identifiers associated with the first and/or subsequent PSCell change, candidate target PSCell identifiers associated with the first and/or subsequent PSCell change, UE 502 measurements (e.g., as indicated by the measurement report described above in connection with reference number 702), execution conditions associated with the first and/or subsequent PSCell change, a base SCG configuration, an indication of an SCG selective activation procedure (e.g., an indication that a PSCell change procedure is associated with a CPC within CPC configuration), or similar information. Because the UE 502 in this example is configured to maintain source SCG and/or MCG configurations after performing the first CPC procedure, measurement identifiers associated with the execution conditions for both the first PSCell change and the subsequent PSCell change may correspond to the source SCG configuration.

As shown by reference number 706, the source MN 504 may transmit, and the source SN 506 and/or the target SN 508 may receive, an SN addition request communication or similar communication, which may be substantially similar to the SN addition request communication or similar communication described above in connection with reference number 606. Moreover, as shown by reference number 708, the source SN 506 and/or the target SN 508 may transmit, and the source MN 504 may receive, an SN addition request ACK communication or similar communication, which may be substantially similar to the SN addition request ACK communication or similar communication described above in connection with reference number 608.

As described above in connection with reference numbers 610 and 612, in some aspects the source SN 506 may provide updated execution conditions to the source MN associated with the first PSCell change after receiving information regarding candidate target PSCells. In such aspects, as shown by reference number 710, the source MN 504 may transmit, and the source SN 506 may receive, an SN modification request communication or similar communication, which may be substantially similar to the SN modification request communication or similar communication described above in connection with reference number 610. In response, and as shown by reference number 712, the source SN 506 may transmit, and the source MN 504 may receive, an SN modification request ACK communication or similar communication, which may be substantially similar to the SN modification request ACK communication or similar communication described above in connection with reference number 612.

As shown in FIG. 7B, the source MN 504 may prepare an RRC configuration message or a similar configuration message including the CPC within CPC configuration (reference number 714), transmit the RRC configuration message or similar message to the UE 502 (reference number 716), receive an RRC reconfiguration complete message or similar message from the UE 502 (reference number 718), and/or transmit an SN change confirmation message or similar message to the source SN 506 (reference number 720), which may be substantially similar to the operations described above in connection with reference numbers 614-620.

Based at least in part on the CPC within CPC configuration, the UE 502 may perform a first CPC procedure in a similar manner as described above in connection with the MN-initiated procedure of FIGS. 5A-5B and the SN-initiated procedure of FIGS. 6A-6B. More particularly, as shown by reference numbers 722, 724, and 726, the UE 502 may perform a first CPC procedure by performing a first CPC evaluation, determining that a first PSCell change has been triggered for a candidate target PSCell, and accessing the candidate target PSCell, which may be performed in a substantially similar manner as described above in connection with reference numbers 526, 528, and 530 and/or reference numbers 622, 624, and 626. In this example, and unlike the operation of the UE 502 described in connection with FIGS. 6A-6B, upon accessing the candidate target PSCell for which the first CPC procedure is triggered, the UE 502 may maintain (e.g., not discard) the base SCG configuration and/or the base MCG configuration. In some aspects, the UE 502 may maintain the base SCG configuration and/or the base MCG configuration based at least in part on receiving a network indication (e.g., an indication transmitted by the source MN 504) that the base SCG configuration and/or the base MCG configuration should be kept after the first CPC trigger.

As shown by reference numbers 728, 730, and 732, the UE 502 may perform a subsequent CPC procedure by performing a subsequent CPC evaluation, determining that a subsequent PSCell change has been triggered for another candidate target PSCell, and accessing the other candidate target PSCell, which may be performed in a substantially similar manner as described above in connection with reference numbers 532, 534, and 536, and reference numbers 628, 630, and 632. In this example, the measurement identifiers associated with the execution conditions for the subsequent PSCell change may correspond to the source SCG configuration, based at least in part on the UE 502 maintaining the base SCG configuration and/or the base MCG configuration following the first PSCell change.

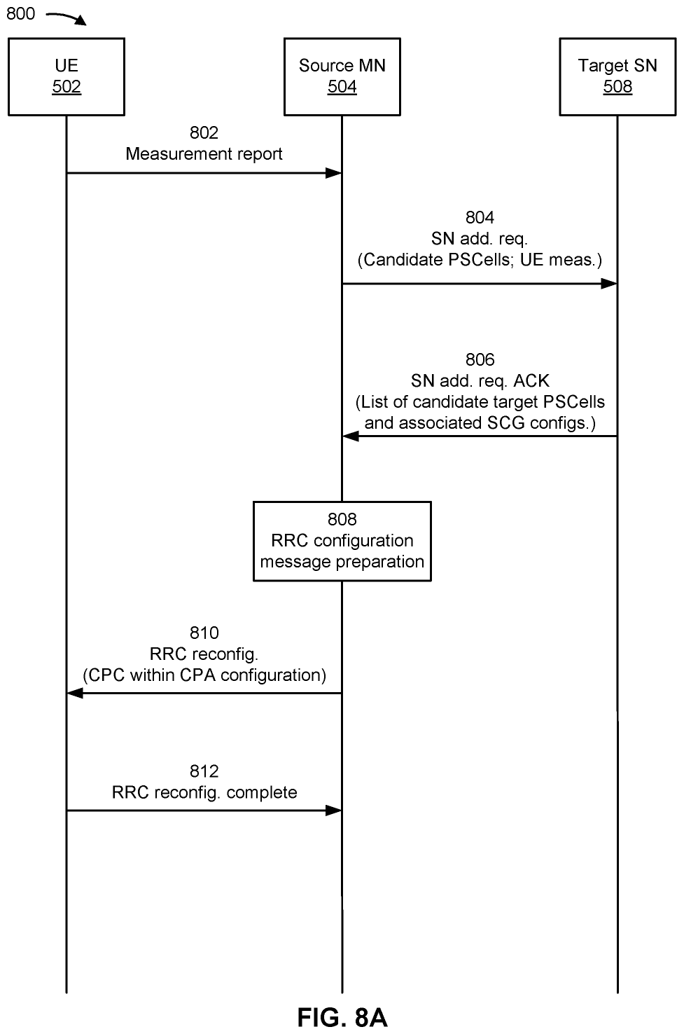

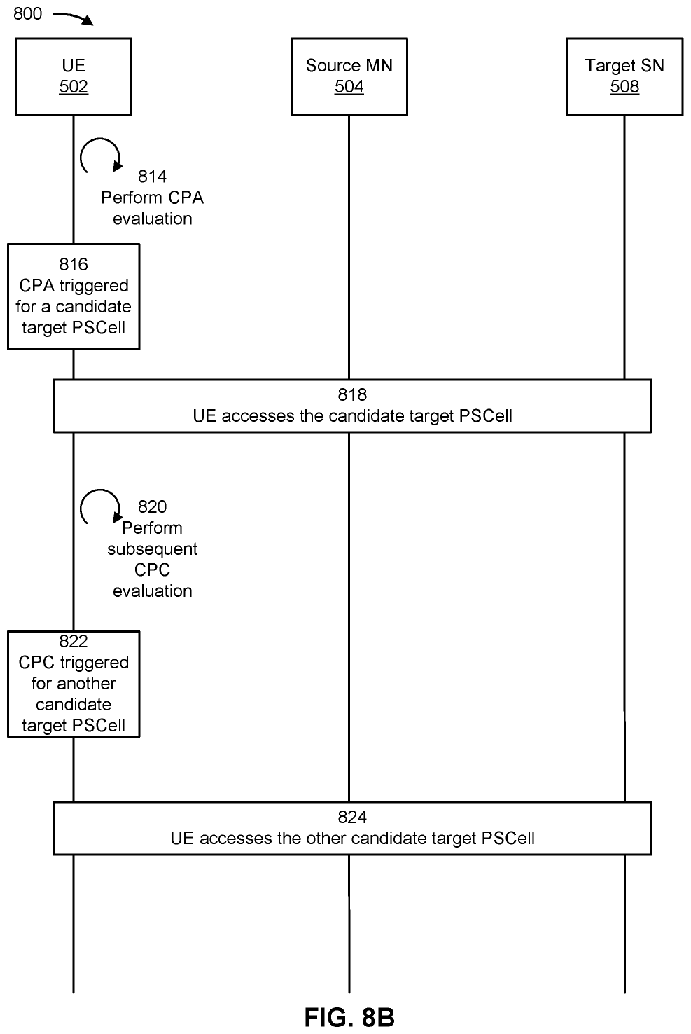

Although the operations described in connection with FIGS. 5A-7B involve a CPC within CPC configuration (e.g., involve a subsequent PSCell change following a first PSCell change), in some other aspects the UE 502 may be configured to perform operations associated with a CPC within CPA configuration (e.g., the UE 502 may be configured to perform a PSCell change procedure following a PSCell addition procedure). Aspects associated with a CPC within CPA configuration are described in more detail below in connection with FIGS. 8A-8B.

As indicated above, FIGS. 7A-7B is provided as an example. Other examples may differ from what is described with respect to FIGS. 7A-7B.

FIGS. 8A-8B are diagrams of an example 800 associated with a CPC configuration within a CPA configuration, in accordance with the present disclosure. In such aspects, the UE 502 may not initially be operating in a dual connectivity mode. That is, the UE 502 in this example may initially be connected only to the source MN 504, but to no SNs. Put another way, the source SN 506 described in connection with FIGS. 5A-7B does not exist in the example shown in FIGS. 8A-8B. In such examples, the UE 502 may enter a dual connectivity mode (e.g., may establish a wireless connection with a SN) via a CPA procedure, and thereafter may perform a PSCell change via a subsequent CPC procedure, such as the subsequent CPC procedures described above in connection with FIGS. 5A-7B. In some aspects, a CPC configuration within a CPA configuration may be referred to as a CPC within CPA configuration.

As shown in FIGS. 8A, and as indicated by reference number 802, the UE 502 may transmit, and the source MN 504 may receive, a measurement report, which may be substantially similar to the measurement report described above in connection with reference number 514. As shown by reference number 804, based at least in part on the measurement report, the source MN 504 may transmit, and the target SN 508 may receive, an SN addition request communication or similar communication. In some aspects, the SN addition request communication or similar communication may include an indication of candidate target PSCells (which may be determined by the source MN 504 based at least in part on the information included in the measurement report) and/or UE 502 measurements included in the measurement report.

As shown by reference number 806, the target SN 508 may transmit, and the source MN 504 may receive, an SN addition request ACK communication or similar communication. The SN addition request ACK communication or similar communication may indicate configuration parameters associated with certain candidate PSCells associated with the target SN 508. For example, the SN addition request ACK communication or similar communication may include a list of candidate target PSCells (for both a CPA procedure and a subsequent CPC procedure) and a corresponding SCG configuration associated with each candidate target PSCell. In some aspects, the corresponding SCG configuration associated with each candidate target PSCell may be full SCG configurations, unlike the examples described above in connection with reference numbers 518, 608, and 708, in which the SCG configurations may be delta configurations with respect a base SCG configuration.

As shown by reference number 808, based at least in part on the information received via the one or more communications described above in connection with reference numbers 802-806, the source MN 504 may prepare an RRC configuration message or a similar configuration message. In some aspects, preparing the RRC configuration message or similar configuration message may include preparing message including a CPC within CPA configuration (e.g., a configuration associated with a subsequent CPC procedure within a configuration associated with a CPA procedure). In some aspects, the RRC configuration message or similar configuration message may include: (1) a base MCG configuration; (2) a CPA configuration including a set of candidate target PSCells, execution conditions for accessing the candidate target PSCells, and/or an SCG configuration and an MCG configuration associated with each candidate target PSCell (including, in some aspects, measurement identifiers associated with the execution conditions, which may correspond to the source MCG measurement configuration); and (3) for each candidate target PSCell indicated by the CPA configuration, a subsequent CPC configuration including a set of candidate target PSCells, execution conditions for accessing the candidate target PSCells, and/or an SCG configuration and an MCG configuration associated with each candidate target PSCell (including, in some aspects, measurement identifiers associated with the execution conditions, which may correspond to the target MCG measurement configuration). In some aspects, at the operations shown in connection with reference number 808, the source MN 504 may determine the base MCG configuration to be used for the first CPC procedure. Additionally, or alternatively, an MCG configuration associated with candidate target PSCell may be indicated as a delta configuration with respect to the base MCG configuration.

As shown by reference number 810, the source MN 504 may transmit, and the UE 502 may receive, configuration information. In some aspects, the UE 502 may receive the configuration information via one or more of RRC signaling, one or more MAC-CEs, and/or DCI, among other examples. For example, in some aspects, the source MN 504 may transmit, and the UE 502 may receive, the configuration information via an RRC reconfiguration message. In some aspects, the configuration information may include an indication of one or more configuration parameters (e.g., already known to the UE 502 and/or previously indicated by the source MN 504 or other network device) for selection by the UE 502, and/or explicit configuration information for the UE 502 to use to configure the UE 502, among other examples.

In some aspects, the configuration information may indicate the CPC within CPA configuration, as described above in connection with reference number 808. Put another way, in some aspects, the source MN 504 may transmit, and the UE 502 may receive, an RRC reconfiguration message that may indicate the base MCG configuration, the CPA configuration (e.g., candidate target PSCells for the CPA procedure and associated SCG and MCG configurations), and/or the subsequent CPC configuration (e.g., for each candidate target PSCell associated with the CPA procedure, corresponding candidate target PSCells for subsequent CPC procedures and associated SCG and MCG configurations).

The UE 502 may configure itself based at least in part on the configuration information. In some aspects, the UE 502 may be configured to perform one or more operations described herein based at least in part on the configuration information. Additionally, in some aspects, the UE 502 may transmit, and the source MN 504 may receive, a message indicating that the UE 502 has configured itself based at least in part on the configuration information, such as the RRC reconfiguration complete message shown in connection with reference number 812.

As shown in FIG. 8B, and as indicated by reference numbers 814-818, based at least in part on the configuration information, the UE 502 may perform a CPA procedure. More particularly, as indicated by reference number 814, the UE 502 may perform a CPA evaluation based at least in part on the CPA configuration. This may include performing measurements (e.g., RSRP measurements, RSRQ measurements, RSSI measurements, SINR measurements, or similar measurements) for frequencies associated with each candidate target PSCell indicated by the CPA configuration, and/or determining if one or more execution conditions has been satisfied for a candidate target PSCell. As shown by reference number 816, when one or more execution conditions has been satisfied for a candidate target PSCell, the UE 502 may determine that a CPA procedure associated with the candidate target PSCell has been triggered, and may initiate a CPA procedure. More particularly, as shown by reference number 818, the UE 502 may access the candidate target PSCell, such as by performing a RACH procedure associated with the candidate target PSCell.

In some aspects, upon accessing the candidate target PSCell via the operations shown in connection with reference number 818, the UE 502 may discard the source MCG configuration, and, in some other aspects, upon accessing the candidate target PSCell via the operations shown in connection with reference number 818, the UE 502 may maintain (e.g., not discard) the source MCG configuration. In aspects in which the UE 502 maintains the source MCG configuration, measurement identifiers associated with execution conditions for a subsequent CPC procedure (described below in connection with reference numbers 820-824) may correspond to the source MCG configuration.

Upon accessing the candidate target PSCell for which the CPA procedure is triggered, the UE 502 may initiate evaluation of the candidate target PSCells corresponding to the newly accessed PSCell, in a similar manner as described above in connection with reference numbers 532-536, 628-632, and/or 728-732. Put another way, the CPC within CPA configuration may include a subsequent CPC configuration for each candidate target PSCell associated with the CPA configuration, such that, after one of the PSCells is accessed via the initial CPA procedure, the UE 502 may begin to monitor execution conditions for a subsequent CPC procedure without being reconfigured by the source MN 504. In that regard, upon accessing a PSCell via the CPA procedure, the UE 502 may perform a subsequent CPC procedure based at least in part on a subsequent CPC configuration associated with the newly accessed PSCell.

More particularly, as indicated by reference numbers 820-824, based at least in part on the configuration information (and, more particularly, the subsequent CPC configuration), the UE 502 may thereafter perform a subsequent CPC procedure without requiring additional information from the source MN 504 (e.g., without being reconfigured by the source MN 504). As indicated by reference number 820, the UE 502 may perform a subsequent CPC evaluation based at least in part on the subsequent CPC configuration. This may include performing measurements (e.g., RSRP measurements, RSRQ measurements, RSSI measurements, SINR measurements, or similar measurements) for frequencies associated with each candidate target PSCell indicated by the subsequent CPC configuration, and/or determining if one or more execution conditions has been satisfied for a candidate target PSCell associated with the subsequent CPC configuration. As shown by reference number 822, when one or more execution conditions has been satisfied for a candidate target PSCell associated with the subsequent CPC configuration, the UE 502 may determine that a CPC procedure associated with the candidate target PSCell has been triggered, and thus may initiate a subsequent CPC procedure to change the PSCell previously added via the CPA procedure. As shown by reference number 824, the UE 502 may thus access the candidate target PSCell, such as by performing a RACH procedure associated with the candidate target PSCell. In some aspects, upon accessing the candidate target PSCell after the subsequent CPC triggers, the UE 502 may discard all stored conditional configurations as well as the source SCG and MCG configurations.

In this way, the UE 502 may perform successive PSCell addition and PSCell change procedures via a single RRC configuration message or similar configuration message (e.g., via a single message including a CPC within CPA configuration), thereby reducing overhead and latency associated with successive PSCell additions and changes, and/or improving link quality and thus reducing power, computing, and communication resource consumption otherwise associated with correcting communication errors.

As indicated above, FIGS. 8A-8B are provided as an example. Other examples may differ from what is described with respect to FIGS. 8A-8B.

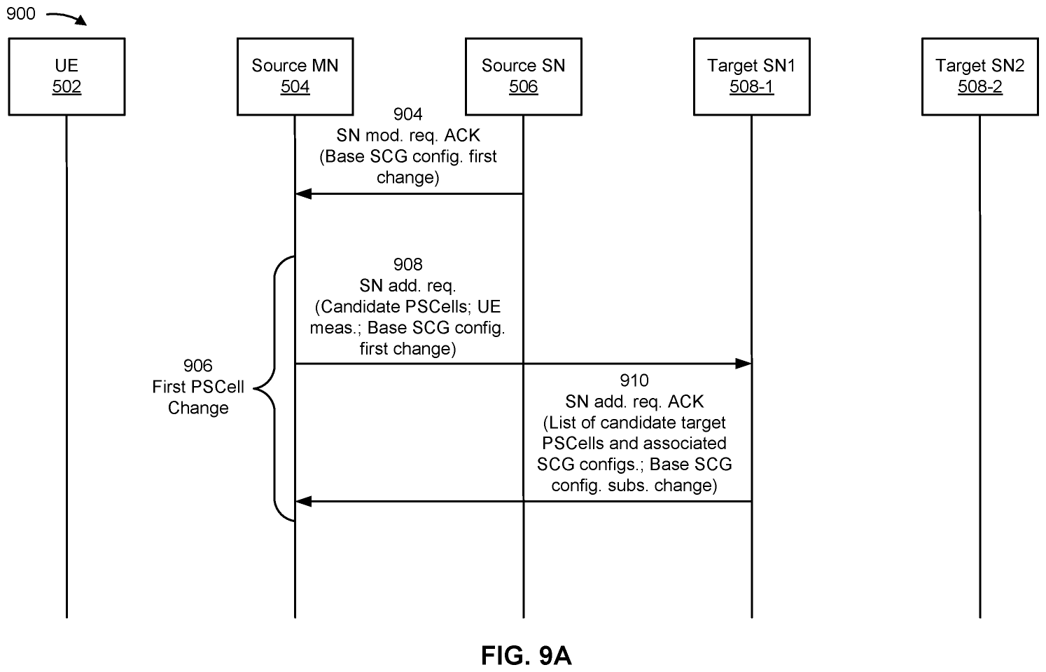

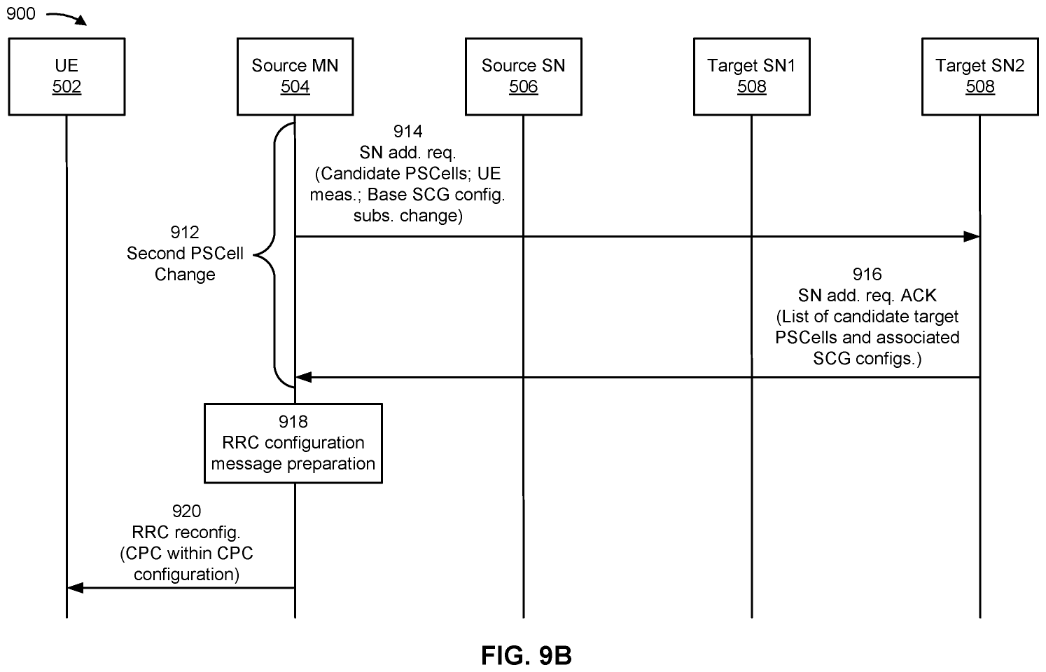

FIGS. 9A-9B are diagrams of an example 700 associated with a CPC configuration within a CPC configuration, in accordance with the present disclosure. More particularly, FIGS. 9A-9B are diagrams associated with a CPC procedure in which one or more target SNs provide base SCG configurations for a subsequent CPC procedure to a source MN.

As shown in FIG. 9A, and as indicated by reference number 904, the source SN 506 may transmit, and the source MN 504 may receive, an SN modification request ACK communication or similar communication, which may correspond to any of the communications described above in connection with reference numbers 512, 612, or 712. In some aspects, the SN modification request ACK communication or similar communication may include an indication of a base SCG configuration to be used during a first PSCell change procedure (e.g., the first CPC procedure described above in connection with FIGS. 5A-7B).

In response, and as shown by reference number 906, the source MN 504 may communicate with a first target SN 508 (shown as target SN1 508-1) in order to receive SCG configuration information associated with a first PSCell change. More particularly, as shown by reference number 908, the source MN 504 may transmit, and the target SN1 508-1 may receive, an SN addition request communication or similar communication, which may correspond to any of the communications described above in connection with reference numbers 516, 606, or 706. In some aspects, the SN addition request communication or similar communication may include an indication of candidate target PSCells, UE 502 measurements (e.g., received via a measurement report), and the base SCG configuration associated with the first PSCell change. In response, and as shown by reference number 910, the target SN1 508-1 may transmit, and the source MN 504 may receive, an SN addition request ACK communication or similar communication, which may correspond to any of the communications described above in connection with reference numbers 518, 608, or 708. In some aspects, the SN addition request ACK communication or similar communication may include a list of candidate target PSCells and associated SCG configurations, as well as a base SCG configuration associated with a subsequent CPC procedure, among other information.

As shown in FIG. 9B, and as indicated by reference number 912, the source MN 504 may communicate with a second target SN 508 (shown as target SN2 508-2) in order to receive SCG configuration information and similar information associated with the second PSCell change (e.g., the subsequent CPC procedure). More particularly, as shown by reference number 914, the source MN 504 may transmit, and the target SN1 508-1 may receive, an SN addition request communication or similar communication, which may correspond to any of the communications described above in connection with reference numbers 516, 606, or 706. In some aspects, the SN addition request communication or similar communication may include an indication of candidate target PSCells, UE 502 measurements (e.g., received via a measurement report), and the base SCG configuration associated with the subsequent PSCell change (e.g., indicated to the source MN 504 via the communication described above in connection with reference number 910). In response, and as shown by reference number 916, the target SN2 508-2 may transmit, and the source MN 504 may receive, an SN addition request ACK communication or similar communication, which may correspond to any of the communications described above in connection with reference numbers 518, 608, or 708. In some aspects, the SN addition request ACK communication or similar communication may include a list of candidate target PSCells and associated SCG configurations.

Based at least in part on the information received from the target SN1 508-1 and/or the target SN2 508-2, the source MN 504 may configure the UE 502 with a CPC within CPC configuration, in a similar manner as described above in connection with FIGS. 5A-7B. More particularly, as shown by reference number 918, the source MN 504 may prepare an RRC configuration message or a similar message, which may correspond to any of the operations described above in connection with reference numbers 520, 614, or 714. Moreover, as shown by reference number 920, the source MN 504 may transmit, and the UE 502 may receive, an RRC reconfiguration message or a similar message including the CPC within CPC configuration, which may correspond to any of the communications described above in connection with reference number 522, 616, or 716. The UE 502 may in turn perform an initial CPC procedure and a subsequent CPC procedure in a similar manner as described above in connection with FIGS. 5A-7B.

Based at least in part on source MN 504 configuring the UE 502 with a CPC within CPC configuration or a CPC within CPA configuration in the manner described above, the UE 502 and/or the source MN 504 may conserve computing, power, network, and/or communication resources that may have otherwise been consumed configuring the UE 502 to perform successive PSCell addition and/or change procedures. For example, based at least in part on the source MN 504 configuring the UE 502 with a CPC within CPC configuration or a CPC within CPA configuration in the manner described above, the UE 502 and the source MN 504 may communicate with reduced overhead and/or a reduced error rate, which may conserve computing, power, network, and/or communication resources that may have otherwise been consumed to signal subsequent CPC configurations and/or to detect and/or correct communication errors.

As indicated above, FIGS. 9A-9B are provided as an example. Other examples may differ from what is described with respect to FIGS. 9A-9B.

FIG. 10 is a diagram illustrating an example process 1000 performed, for example, by a UE, in accordance with the present disclosure. Example process 1000 is an example where the UE (e.g., UE 120) performs operations associated with a conditional PSCell change configuration within a conditional cell addition or change configuration.

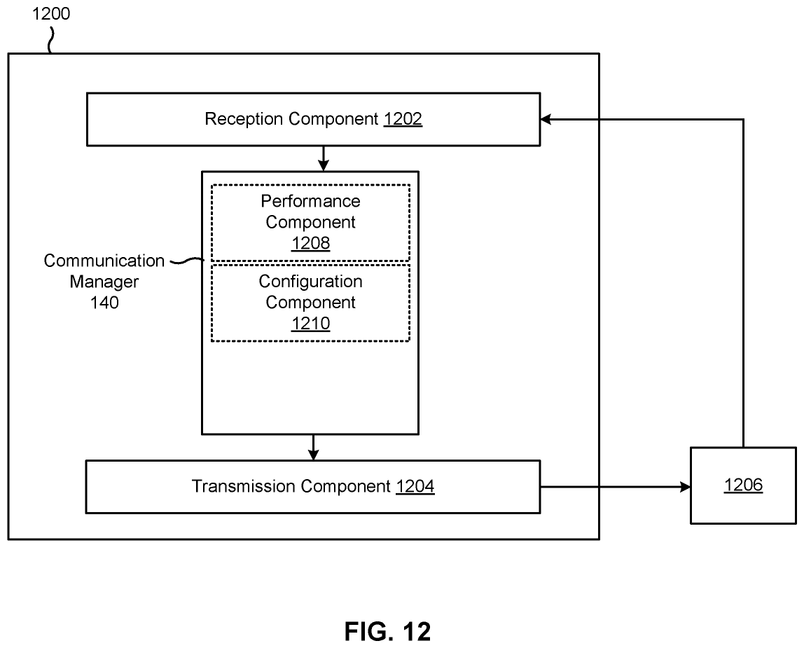

As shown in FIG. 10, in some aspects, process 1000 may include receiving configuration information indicating: one of CPA configuration associated with a CPA procedure or a CPC configuration associated with a first CPC procedure, and a subsequent CPC configuration associated with a second CPC procedure (block 1010). For example, the UE (e.g., using communication manager 140 and/or reception component 1202, depicted in FIG. 12) may receive configuration information indicating: one of a CPA configuration associated with a CPA procedure or a CPC configuration associated with a first CPC procedure, and a subsequent CPC configuration associated with a second CPC procedure, as described above.

As further shown in FIG. 10, in some aspects, process 1000 may include performing one of the CPA procedure or the first CPC procedure based at least in part on the one of the CPA configuration or the CPC configuration (block 1020). For example, the UE (e.g., using communication manager 140 and/or performance component 1208, depicted in FIG. 12) may perform one of the CPA procedure or the first CPC procedure based at least in part on the one of the CPA configuration or the CPC configuration, as described above.

As further shown in FIG. 10, in some aspects, process 1000 may include performing the second CPC procedure based at least in part on the subsequent CPC configuration (block 1030). For example, the UE (e.g., using communication manager 140 and/or performance component 1208, depicted in FIG. 12) may perform the second CPC procedure based at least in part on the subsequent CPC configuration, as described above.

Process 1000 may include additional aspects, such as any single aspect or any combination of aspects described below and/or in connection with one or more other processes described elsewhere herein.

In a first aspect, process 1000 includes transmitting a measurement report indicating measurements associated with one or more target PSCells, wherein receiving the configuration information is based at least in part on the measurement report.

In a second aspect, alone or in combination with the first aspect, the measurement report is transmitted to one of a master node associated with a master cell group, or a secondary node associated with a secondary cell group of a multi-radio access technology (multi-RAT) dual connectivity (MR-DC) system.

In a third aspect, alone or in combination with one or more of the first and second aspects, the configuration information is based at least in part on at least one of a base SCG configuration or a base MCG configuration, and the configuration information indicates, for each of multiple target PSCells, a delta configuration associated with the at least one of the base SCG configuration or the base MCG configuration.

In a fourth aspect, alone or in combination with one or more of the first through third aspects, the configuration information includes an indication that the configuration information includes the delta configuration for each of the multiple target PSCells.

In a fifth aspect, alone or in combination with one or more of the first through fourth aspects, the one of the CPA configuration or the CPC configuration is based at least in part on a first base SCG configuration, and the subsequent CPC configuration is based at least in part on a second base SCG configuration.

In a sixth aspect, alone or in combination with one or more of the first through fifth aspects, the configuration information includes multiple measurement identifiers associated with execution conditions of multiple target PSCells, and each measurement identifier, of the multiple measurement identifiers, is associated with a target master cell group configuration associated with a corresponding target cell, of the multiple target PSCells.

In a seventh aspect, alone or in combination with one or more of the first through sixth aspects, process 1000 includes maintaining at least one of a base SCG configuration or a base MCG configuration associated with the one of the CPA procedure or the first CPC procedure after performing the one of the CPA procedure or the first CPC procedure, wherein performing the second CPC procedure is based at least in part on the at least one of the base SCG configuration or the base MCG configuration associated with the one of the CPA procedure or the first CPC procedure.

In an eighth aspect, alone or in combination with one or more of the first through seventh aspects, process 1000 includes receiving an indication that the at least one of the base SCG configuration or the base MCG configuration associated with the one of the CPA procedure or the first CPC procedure is to be maintained after the one of the CPA procedure or the first CPC procedure is performed.

In a ninth aspect, alone or in combination with one or more of the first through eighth aspects, process 1000 includes maintaining a source SCG configuration and a source MCG configuration after performing the one of the CPA procedure or the first CPC procedure, wherein the subsequent CPC configuration indicates multiple measurement identifiers associated with multiple target PSCells, and wherein each measurement identifier, of the multiple measurement identifiers, corresponds to the source MCG configuration.

In a tenth aspect, alone or in combination with one or more of the first through ninth aspects, process 1000 includes discarding the configuration information after performing the second CPC procedure.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with a conditional PSCell change configuration within a conditional cell addition or change configuration.

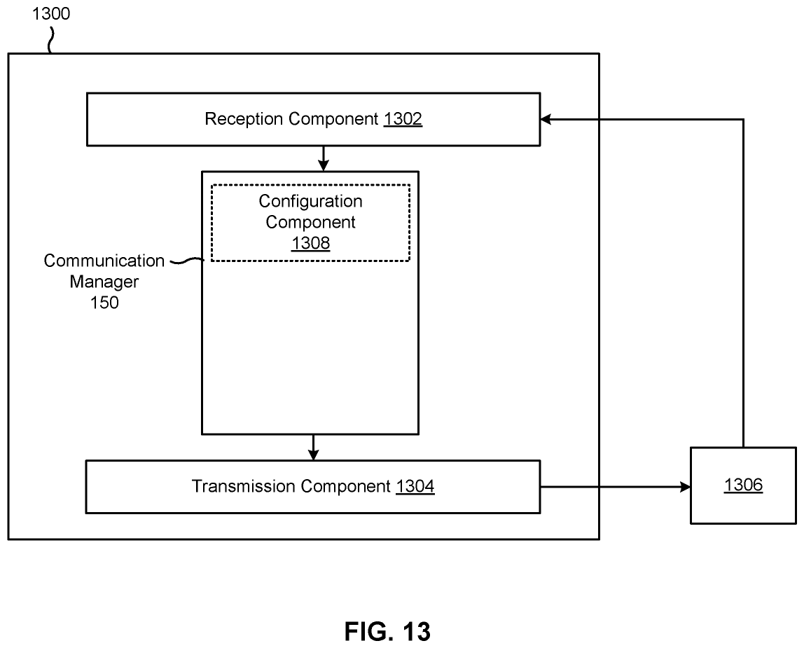

As shown in FIG. 11, in some aspects, process 1100 may include receiving, from one or more other network nodes, multiple SCG configurations (block 1110). For example, the network node (e.g., using communication manager 150 and/or reception component 1302, depicted in FIG. 13) may receive, from one or more other network nodes, multiple SCG configurations, as described above.

As further shown in FIG. 11, in some aspects, process 1100 may include transmitting, to a UE, configuration information based at least in part on the multiple SCG configurations, the configuration information indicating: one of a CPA configuration associated with a CPA procedure or a CPC configuration associated with a first CPC procedure, and a subsequent CPC configuration associated with a second CPC procedure (block 1120). For example, the network node (e.g., using communication manager 150, transmission component 1304, and/or configuration component 1308, depicted in FIG. 13) may transmit, to a UE, configuration information based at least in part on the multiple SCG configurations, the configuration information indicating: one of a CPA configuration associated with a CPA procedure or a CPC configuration associated with a first CPC procedure, and a subsequent CPC configuration associated with a second CPC procedure, as described above.

Process 1100 may include additional aspects, such as any single aspect or any combination of aspects described below and/or in connection with one or more other processes described elsewhere herein.

In a first aspect, process 1100 includes receiving a measurement report indicating measurements associated with one or more target PSCells, wherein transmitting the configuration information is based at least in part on the measurement report.

In a second aspect, alone or in combination with the first aspect, the configuration information is based at least in part on at least one of a base SCG configuration or a base MCG configuration, and the configuration information indicates, for each of multiple target PSCells, a delta configuration associated with the at least one of the base SCG configuration or the base MCG configuration.

In a third aspect, alone or in combination with one or more of the first and second aspects, the configuration information includes an indication that the configuration information includes the delta configuration for each of the multiple target PSCells.

In a fourth aspect, alone or in combination with one or more of the first through third aspects, the one of the CPA configuration or the CPC configuration is based at least in part on a first base SCG configuration, and the subsequent CPC configuration is based at least in part on a second base SCG configuration.

In a fifth aspect, alone or in combination with one or more of the first through fourth aspects, the configuration information includes multiple measurement identifiers associated with execution conditions of multiple target PSCells, and each measurement identifier, of the multiple measurement identifiers, is associated with a target master cell group configuration associated with a corresponding target cell, of the multiple target PSCells.

In a sixth aspect, alone or in combination with one or more of the first through fifth aspects, process 1100 includes transmitting, to the UE, an indication that at least one of a base secondary cell group configuration or a base master cell group configuration is to be maintained after performing the one of the CPA procedure or the first CPC procedure.

In a seventh aspect, alone or in combination with one or more of the first through sixth aspects, the multiple SCG configurations include a base SCG configuration and multiple delta configurations, and each of the multiple delta configurations is associated with a corresponding target cell.

In an eighth aspect, alone or in combination with one or more of the first through seventh aspects, process 1100 includes transmitting, to the one or more other network nodes, a first message, wherein the base SCG configuration is received via a second message received in response to the first message.

In a ninth aspect, alone or in combination with one or more of the first through eighth aspects, process 1100 includes transmitting, to the one or more other network nodes, a secondary node addition request, wherein the multiple delta configurations are received via one or more secondary node addition request acknowledgement communications.

In a tenth aspect, alone or in combination with one or more of the first through ninth aspects, process 1100 includes receiving, from the one or more other network nodes, an indication that the multiple SCG configurations are associated with the multiple delta configurations.

In an eleventh aspect, alone or in combination with one or more of the first through tenth aspects, the configuration information includes multiple measurement identifiers associated with execution conditions of multiple target PSCells, a first set of the multiple measurement identifiers are associated with the one of the CPA configuration or the CPC configuration and are associated with a source secondary cell group measurement configuration, and a second set of the multiple measurement identifiers are associated with the subsequent CPC configuration and are associated with a target secondary cell group measurement configuration.

In a twelfth aspect, alone or in combination with one or more of the first through eleventh aspects, the configuration information includes multiple measurement identifiers associated with execution conditions of multiple target PSCells, and the multiple measurement identifiers are associated with a source master cell group configuration associated with the network node.

In a thirteenth aspect, alone or in combination with one or more of the first through twelfth aspects, the multiple SCG configurations are associated with a secondary node change required communication received from a source network node, and the secondary node change required communication further indicates at least one of target secondary node identifiers associated with the one of the first CPC procedure or the second CPC procedure, candidate PSCell identifiers associated with the one of the first CPC procedure or the second CPC procedure, information associated with execution conditions associated with the one of the first CPC procedure or the second CPC procedure, a base secondary cell group confirmation, or an indication of a selective activation procedure.

In a fourteenth aspect, alone or in combination with one or more of the first through thirteenth aspects, process 1100 includes transmitting, to at least one target secondary node, information associated with execution conditions associated with the second CPC procedure, and receiving, from the at least one target secondary node, an indication of one or more candidate target PSCells and associated execution conditions for the second CPC procedure.

In a fifteenth aspect, alone or in combination with one or more of the first through fourteenth aspects, process 1100 includes transmitting, to a source secondary node, a message indicating at least one of one or more candidate target PSCells associated with the first CPC procedure, and receiving, from the source secondary node, updated information associated with execution conditions associated with the first CPC procedure.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 502), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include the communication manager 140. The communication manager 140 may include one or more of a performance component 1208, or a configuration component 1210, among other examples.

In some aspects, the apparatus 1200 may be configured to perform one or more operations described herein in connection with FIGS. 5A-9B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE 120 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE 120 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE 120 described in connection with FIG. 2. In some aspects, the transmission component 1204 may be co-located with the reception component 1202 in a transceiver.

The reception component 1202 may receive configuration information indicating one of a CPA configuration associated with a CPA procedure or a CPC configuration associated with a first CPC procedure, and a subsequent CPC configuration associated with a second CPC procedure. The performance component 1208 may perform one of the CPA procedure or the first CPC procedure based at least in part on the one of the CPA configuration or the CPC configuration. The performance component 1208 may perform the second CPC procedure based at least in part on the subsequent CPC configuration.

The transmission component 1204 may transmit a measurement report indicating measurements associated with one or more target PSCells, wherein receiving the configuration information is based at least in part on the measurement report.

The configuration component 1210 may maintain at least one of a base SCG configuration or a base MCG configuration associated with the one of the CPA procedure or the first CPC procedure after performing the one of the CPA procedure or the first CPC procedure, wherein performing the second CPC procedure is based at least in part on the at least one of the base SCG configuration or the base MCG configuration associated with the one of the CPA procedure or the first CPC procedure.

The reception component 1202 may receive an indication that the at least one of the base SCG configuration or the base MCG configuration associated with the one of the CPA procedure or the first CPC procedure is to be maintained after the one of the CPA procedure or the first CPC procedure is performed.

The configuration component 1210 may maintain a source SCG configuration and a source MCG configuration after performing the one of the CPA procedure or the first CPC procedure, wherein the subsequent CPC configuration indicates multiple measurement identifiers associated with multiple target PSCells, and wherein each measurement identifier, of the multiple measurement identifiers, corresponds to the source MCG configuration.

The configuration component 1210 may discard the configuration information after performing the second CPC procedure.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node (e.g., source MN 504, source SN 506, or target SN 508), or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a network node, or another wireless communication device) using the reception component 1302 and the transmission component 1304. As further shown, the apparatus 1300 may include the communication manager 150. The communication manager 150 may include a configuration component 1308, among other examples.

In some aspects, the apparatus 1300 may be configured to perform one or more operations described herein in connection with FIGS. 5A-9B. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node 110 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node 110 described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node 110 described in connection with FIG. 2. In some aspects, the transmission component 1304 may be co-located with the reception component 1302 in a transceiver.

The reception component 1302 may receive, from one or more other network nodes, multiple SCG configurations. The transmission component 1304 and/or the configuration component 1308 may transmit, to a UE, configuration information based at least in part on the multiple SCG configurations, the configuration information indicating one of a CPA configuration associated with a CPA procedure or a CPC configuration associated with a first CPC procedure, and a subsequent CPC configuration associated with a second CPC procedure.

The reception component 1302 may receive a measurement report indicating measurements associated with one or more target PSCells, wherein transmitting the configuration information is based at least in part on the measurement report.

The transmission component 1304 may transmit, to the UE, an indication that at least one of a base secondary cell group configuration or a base master cell group configuration is to be maintained after performing the one of the CPA procedure or the first CPC procedure.

The transmission component 1304 may transmit, to the one or more other network nodes, a first message, wherein the base SCG configuration is received via a second message received in response to the first message.

The transmission component 1304 may transmit, to the one or more other network nodes, a secondary node addition request, wherein the multiple delta configurations are received via one or more secondary node addition request acknowledgement communications.

The reception component 1302 may receive, from the one or more other network nodes, an indication that the multiple SCG configurations are associated with the multiple delta configurations.

The transmission component 1304 may transmit, to at least one target secondary node, information associated with execution conditions associated with the second CPC procedure.

The reception component 1302 may receive, from the at least one target secondary node, an indication of one or more candidate target PSCells and associated execution conditions for the second CPC procedure.

The transmission component 1304 may transmit, to a source secondary node, a message indicating at least one of one or more candidate target PSCells associated with the first CPC procedure.

The reception component 1302 may receive, from the source secondary node, updated information associated with execution conditions associated with the first CPC procedure.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving configuration information indicating: one of a CPA configuration associated with a CPA procedure or a CPC configuration associated with a first CPC procedure, and a subsequent CPC configuration associated with a second CPC procedure; performing one of the CPA procedure or the first CPC procedure based at least in part on the one of the CPA configuration or the CPC configuration; and performing the second CPC procedure based at least in part on the subsequent CPC configuration.

Aspect 2: The method of Aspect 1, further comprising transmitting a measurement report indicating measurements associated with one or more target PSCells, wherein receiving the configuration information is based at least in part on the measurement report.

Aspect 3: The method of Aspect 2, wherein the measurement report is transmitted to one of a master node associated with a master cell group, or a secondary node associated with a secondary cell group of a multi-radio access technology (multi-RAT) dual connectivity (MR-DC) system.

Aspect 4: The method of any of Aspects 1-3, wherein the configuration information is based at least in part on at least one of a base SCG configuration or a base MCG configuration, and wherein the configuration information indicates, for each of multiple target PSCells, a delta configuration associated with the at least one of the base SCG configuration or the base MCG configuration.

Aspect 5: The method of Aspect 4, wherein the configuration information includes an indication that the configuration information includes the delta configuration for each of the multiple target PSCells.

Aspect 6: The method of any of Aspects 1-5, wherein the one of the CPA configuration or the CPC configuration is based at least in part on a first base SCG configuration, and wherein the subsequent CPC configuration is based at least in part on a second base SCG configuration.

Aspect 7: The method of any of Aspects 1-6, wherein the configuration information includes multiple measurement identifiers associated with execution conditions of multiple target PSCells, wherein each measurement identifier, of the multiple measurement identifiers, is associated with a target master cell group configuration associated with a corresponding target cell, of the multiple target PSCells.

Aspect 8: The method of any of Aspects 1-7, further comprising maintaining at least one of a base SCG configuration or a base MCG configuration associated with the one of the CPA procedure or the first CPC procedure after performing the one of the CPA procedure or the first CPC procedure, wherein performing the second CPC procedure is based at least in part on the at least one of the base SCG configuration or the base MCG configuration associated with the one of the CPA procedure or the first CPC procedure.

Aspect 9: The method of Aspect 8, further comprising receiving an indication that the at least one of the base SCG configuration or the base MCG configuration associated with the one of the CPA procedure or the first CPC procedure is to be maintained after the one of the CPA procedure or the first CPC procedure is performed.

Aspect 10: The method of any of Aspects 1-9, further comprising maintaining a source SCG configuration and a source MCG configuration after performing the one of the CPA procedure or the first CPC procedure, wherein the subsequent CPC configuration indicates multiple measurement identifiers associated with multiple target PSCells, and wherein each measurement identifier, of the multiple measurement identifiers, corresponds to the source MCG configuration.

Aspect 11: The method of any of Aspects 1-10, further comprising discarding the configuration information after performing the second CPC procedure.

Aspect 12: A method of wireless communication performed by a network node, comprising: receiving, from one or more other network nodes, multiple SCG configurations; and transmitting, to a UE, configuration information based at least in part on the multiple SCG configurations, the configuration information indicating: one of a CPA configuration associated with a CPA procedure or a CPC configuration associated with a first CPC procedure, and a subsequent CPC configuration associated with a second CPC procedure.

Aspect 13: The method of Aspect 12, further comprising receiving a measurement report indicating measurements associated with one or more target PSCells, wherein transmitting the configuration information is based at least in part on the measurement report.

Aspect 14: The method of any of Aspects 12-13, wherein the configuration information is based at least in part on at least one of a base SCG configuration or a base MCG configuration, and wherein the configuration information indicates, for each of multiple target PSCells, a delta configuration associated with the at least one of the base SCG configuration or the base MCG configuration.

Aspect 15: The method of Aspect 14, wherein the configuration information includes an indication that the configuration information includes the delta configuration for each of the multiple target PSCells.

Aspect 16: The method of any of Aspects 12-15, wherein the one of the CPA configuration or the CPC configuration is based at least in part on a first base SCG configuration, and wherein the subsequent CPC configuration is based at least in part on a second base SCG configuration.

Aspect 17: The method of any of Aspects 12-16, wherein the configuration information includes multiple measurement identifiers associated with execution conditions of multiple target PSCells, wherein each measurement identifier, of the multiple measurement identifiers, is associated with a target master cell group configuration associated with a corresponding target cell, of the multiple target PSCells.

Aspect 18: The method of any of Aspects 12-17, further comprising transmitting, to the UE, an indication that at least one of a base secondary cell group configuration or a base master cell group configuration is to be maintained after performing the one of the CPA procedure or the first CPC procedure.

Aspect 19: The method of any of Aspects 12-18, wherein the multiple SCG configurations include a base SCG configuration and multiple delta configurations, wherein each of the multiple delta configurations is associated with a corresponding target cell.

Aspect 20: The method of Aspect 19, further comprising transmitting, to the one or more other network nodes, a first message, wherein the base SCG configuration is received via a second message received in response to the first message.

Aspect 21: The method of Aspect 19, further comprising transmitting, to the one or more other network nodes, a secondary node addition request, wherein the multiple delta configurations are received via one or more secondary node addition request acknowledgement communications.

Aspect 22: The method of Aspect 19, further comprising receiving, from the one or more other network nodes, an indication that the multiple SCG configurations are associated with the multiple delta configurations.

Aspect 23: The method of any of Aspects 12-22, wherein the configuration information includes multiple measurement identifiers associated with execution conditions of multiple target PSCells, wherein a first set of the multiple measurement identifiers are associated with the one of the CPA configuration or the CPC configuration and are associated with a source secondary cell group measurement configuration, and wherein a second set of the multiple measurement identifiers are associated with the subsequent CPC configuration and are associated with a target secondary cell group measurement configuration.

Aspect 24: The method of any of Aspects 12-23, wherein the configuration information includes multiple measurement identifiers associated with execution conditions of multiple target PSCells, and wherein the multiple measurement identifiers are associated with a source master cell group configuration associated with the network node.

Aspect 25: The method of any of Aspects 12-24, wherein the multiple SCG configurations are associated with a secondary node change required communication received from a source network node, and wherein the secondary node change required communication further indicates at least one of: target secondary node identifiers associated with the one of the first CPC procedure or the second CPC procedure, candidate PSCell identifiers associated with the one of the first CPC procedure or the second CPC procedure, information associated with execution conditions associated with the one of the first CPC procedure or the second CPC procedure, a base secondary cell group confirmation, or an indication of a selective activation procedure.

Aspect 26: The method of any of Aspects 12-25, further comprising: transmitting, to at least one target secondary node, information associated with execution conditions associated with the second CPC procedure; and receiving, from the at least one target secondary node, an indication of one or more candidate target PSCells and associated execution conditions for the second CPC procedure.

Aspect 27: The method of any of Aspects 12-26, further comprising: transmitting, to a source secondary node, a message indicating at least one of one or more candidate target PSCells associated with the first CPC procedure, and receiving, from the source secondary node, updated information associated with execution conditions associated with the first CPC procedure.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive configuration information indicating:
one of a conditional primary secondary cell (PSCell) addition (CPA) configuration associated with a CPA procedure or a conditional PSCell change (CPC) configuration associated with a first CPC procedure, and
a subsequent CPC configuration associated with a second CPC procedure;
perform one of the CPA procedure or the first CPC procedure based at least in part on the one of the CPA configuration or the CPC configuration; and
perform the second CPC procedure based at least in part on the subsequent CPC configuration.

2. The UE of claim 1, wherein the one or more processors are further configured to transmit a measurement report indicating measurements associated with one or more target PSCells, wherein receiving the configuration information is based at least in part on the measurement report.

3. The UE of claim 2, wherein the one or more processors are further configured to transmit the measurement report to one of a master node associated with a master cell group, or a secondary node associated with a secondary cell group of a multi-radio access technology (multi-RAT) dual connectivity (MR-DC) system.

4. The UE of claim 1, wherein the configuration information is based at least in part on at least one of a base secondary cell group (SCG) configuration or a base master cell group (MCG) configuration, and wherein the configuration information indicates, for each of multiple target PSCells, a delta configuration associated with the at least one of the base SCG configuration or the base MCG configuration.

5. The UE of claim 4, wherein the configuration information includes an indication that the configuration information includes the delta configuration for each of the multiple target PSCells.

6. The UE of claim 1, wherein the one of the CPA configuration or the CPC configuration is based at least in part on a first base secondary cell group (SCG) configuration, and wherein the subsequent CPC configuration is based at least in part on a second base SCG configuration.

7. The UE of claim 1, wherein the configuration information includes multiple measurement identifiers associated with execution conditions of multiple target PSCells, wherein each measurement identifier, of the multiple measurement identifiers, is associated with a target master cell group configuration associated with a corresponding target cell, of the multiple target PSCells.

8. The UE of claim 1, wherein the one or more processors are further configured to maintain at least one of a base secondary cell group (SCG) configuration or a base master cell group (MCG) configuration associated with the one of the CPA procedure or the first CPC procedure after performing the one of the CPA procedure or the first CPC procedure, wherein performing the second CPC procedure is based at least in part on the at least one of the base SCG configuration or the base MCG configuration associated with the one of the CPA procedure or the first CPC procedure.

9. The UE of claim 8, wherein the one or more processors are further configured to receive an indication that the at least one of the base SCG configuration or the base MCG configuration associated with the one of the CPA procedure or the first CPC procedure is to be maintained after the one of the CPA procedure or the first CPC procedure is performed.

10. The UE of claim 1, wherein the one or more processors are further configured to maintain a source secondary cell group (SCG) configuration and a source master cell group (MCG) configuration after performing the one of the CPA procedure or the first CPC procedure, wherein the subsequent CPC configuration indicates multiple measurement identifiers associated with multiple target PSCells, and wherein each measurement identifier, of the multiple measurement identifiers, corresponds to the source MCG configuration.

11. The UE of claim 1, wherein the one or more processors are further configured to discard the configuration information after performing the second CPC procedure.

12. A network node for wireless communication, comprising:
a memory; and
one or more processors, coupled to the memory, configured to:
receive, from one or more other network nodes, multiple secondary cell group (SCG) configurations; and
transmit, to a user equipment (UE), configuration information based at least in part on the multiple SCG configurations, the configuration information indicating:
one of a conditional primary secondary cell (PSCell) addition (CPA) configuration associated with a CPA procedure or a conditional PSCell change (CPC) configuration associated with a first CPC procedure, and
a subsequent CPC configuration associated with a second CPC procedure.

13. The network node of claim 12, wherein the one or more processors are further configured to:
receive a measurement report indicating measurements associated with one or more target PSCells; and
transmit the configuration information based at least in part on the measurement report.

14. The network node of claim 12, wherein the configuration information is based at least in part on at least one of a base secondary cell group (SCG) configuration or a base master cell group (MCG) configuration, and wherein the configuration information indicates, for each of multiple target PSCells, a delta configuration associated with the at least one of the base SCG configuration or the base MCG configuration.

15. The network node of claim 14, wherein the configuration information includes an indication that the configuration information includes the delta configuration for each of the multiple target PSCells.

16. The network node of claim 12, wherein the one of the CPA configuration or the CPC configuration is based at least in part on a first base secondary cell group (SCG) configuration, and wherein the subsequent CPC configuration is based at least in part on a second base SCG configuration.

17. The network node of claim 12, wherein the configuration information includes multiple measurement identifiers associated with execution conditions of multiple target PSCells, wherein each measurement identifier, of the multiple measurement identifiers, is associated with a target master cell group configuration associated with a corresponding target cell, of the multiple target PSCells.

18. The network node of claim 12, wherein the one or more processors are further configured to transmit, to the UE, an indication that at least one of a base secondary cell group configuration or a base master cell group configuration is to be maintained after performing the one of the CPA procedure or the first CPC procedure.

19. The network node of claim 12, wherein the multiple SCG configurations include a base SCG configuration and multiple delta configurations, wherein each of the multiple delta configurations is associated with a corresponding target cell.

20. The network node of claim 19, wherein the one or more processors are further configured to:
transmit, to the one or more other network nodes, a first message; and
receive, in response to the first message, the base SCG configuration.

21. The network node of claim 19, wherein the one or more processors are further configured to:
transmit, to the one or more other network nodes, a secondary node addition request; and
receive the multiple delta configurations via one or more secondary node addition request acknowledgement communications.

22. The network node of claim 19, wherein the one or more processors are further configured to receive, from the one or more other network nodes, an indication that the multiple SCG configurations are associated with the multiple delta configurations.

23. The network node of claim 12, wherein the configuration information includes multiple measurement identifiers associated with execution conditions of multiple target PSCells,
wherein a first set of the multiple measurement identifiers are associated with the one of the CPA configuration or the CPC configuration and are associated with a source secondary cell group measurement configuration, and
wherein a second set of the multiple measurement identifiers are associated with the subsequent CPC configuration and are associated with a target secondary cell group measurement configuration.

24. The network node of claim 12, wherein the configuration information includes multiple measurement identifiers associated with execution conditions of multiple target PSCells, and wherein the multiple measurement identifiers are associated with a source master cell group configuration associated with the network node.

25. The network node of claim 12, wherein the multiple SCG configurations are associated with a secondary node change required communication received from a source network node, and wherein the secondary node change required communication further indicates at least one of:
target secondary node identifiers associated with the one of the first CPC procedure or the second CPC procedure,
candidate PSCell identifiers associated with the one of the first CPC procedure or the second CPC procedure,
information associated with execution conditions associated with the one of the first CPC procedure or the second CPC procedure,
a base secondary cell group confirmation, or
an indication of a selective activation procedure.

26. The network node of claim 12, wherein the one or more processors are further configured to:
transmit, to at least one target secondary node, information associated with execution conditions associated with the second CPC procedure; and
receive, from the at least one target secondary node, an indication of one or more candidate target PSCells and associated execution conditions for the second CPC procedure.

27. A method of wireless communication performed by a user equipment (UE), comprising:
receiving configuration information indicating:
one of a conditional primary secondary cell (PSCell) addition (CPA) configuration associated with a CPA procedure or a conditional PSCell change (CPC) configuration associated with a first CPC procedure, and
a subsequent CPC configuration associated with a second CPC procedure;
performing one of the CPA procedure or the first CPC procedure based at least in part on the one of the CPA configuration or the CPC configuration; and
performing the second CPC procedure based at least in part on the subsequent CPC configuration.

28. The method of claim 27, further comprising transmitting a measurement report indicating measurements associated with one or more target PSCells, wherein receiving the configuration information is based at least in part on the measurement report.

29. A method of wireless communication performed by a network node, comprising:
receiving, from one or more other network nodes, multiple secondary cell group (SCG) configurations; and
transmitting, to a user equipment (UE), configuration information based at least in part on the multiple SCG configurations, the configuration information indicating:
one of a conditional primary secondary cell (PSCell) addition (CPA) configuration associated with a CPA procedure or a conditional PSCell change (CPC) configuration associated with a first CPC procedure, and
a subsequent CPC configuration associated with a second CPC procedure.

30. The method of claim 29, wherein the configuration information is based at least in part on at least one of a base secondary cell group (SCG) configuration or a base master cell group (MCG) configuration, and wherein the configuration information indicates, for each of multiple target PSCells, a delta configuration associated with the at least one of the base SCG configuration or the base MCG configuration.
